(19) United States
(12) Patent Application Publication
(10) Pub. No.: US 2025/0343983 A1
(43) Pub. Date: Nov. 6, 2025

(54) PICTURE RECORDING ARRANGEMENT, LIGHT SOURCE AND METHOD FOR OPERATING A PICTURE RECORDING ARRANGEMENT

(71) Applicant: ams International AG, Jona (CH)

(72) Inventors: Alessandro PIOTTO, Thalwil (CH); Andrea DI CHELE, Winterthur (CH); Vladimir GRÜNDLING, Fürstenfeld (AT); Davide SOLIDA, Hausen am Albis (CH); Kian Boon Kelvin QUAH, Singapore (SG); Johannes HAASE, Wädenswil (CH); Matis HUDON, Charenton-le-pont (FR)

(21) Appl. No.: 18/870,734

(22) PCT Filed: May 24, 2023
(86) PCT No.: PCT/EP2023/063934

§ 371 Date: Dec. 2, 2024

(30) Foreign Application Priority Data
Jun. 3, 2022 (DE) 10 2022 114 174.8
Jul. 11, 2022 (DE) 10 2022 117 234.1
Sep. 14, 2022 (DE) 10 2022 123 473.8
Dec. 15, 2022 (DE) 10 2022 133 387.6

(51) Int. Cl. H04N 23/56; H04N 23/51; H04N 23/55

(52) U.S. Cl. CPC H04N 23/56; H04N 23/51; H04N 23/55

(57) ABSTRACT

A picture recording arrangement includes an image sensor. The picture recording arrangement also includes a light source configured to emit radiation along a plurality of emission directions. The light source includes a plurality of independently controllable light-emitting units. For each one of the emission directions, there is at least one of the light-emitting units. The radiation emitted into the emission directions is emitted predominantly out of a field of view of the image sensor.

A picture recording arrangement, a light source and a method for operating a picture recording arrangement are provided.

Documents U.S. Pat. Nos. 10,091,433 B1 and 10,659,668 B2 refer to devices to create illumination conditions.

A problem to be solved is to provide a picture recording arrangement, a corresponding light source and a method for operating a picture recording arrangement for achieving improved image quality.

This object is achieved, inter alia, by a picture recording arrangement, by a light source and by a method for operating a picture recording arrangement as defined in the independent patent claims. Exemplary further developments constitute the subject-matter of the dependent claims.

With the picture recording arrangement described herein, for example, indirect illumination of a target to be imaged can be provided, and directions from which the indirect illumination comes from can be adjusted by emitting a defined light pattern next to the target by controlling an adjustable photo flash which is realized in particular by a multi-LED light source.

According to at least one embodiment, the picture recording arrangement comprises one or a plurality of image sensors, like CCD sensors. For example, the image sensor includes some million pixels and/or is color-sensitive. The term ‘image sensor’ may be understood in this context to also include imaging optics; thus, in the following the term ‘image sensor’ may be equivalent to the term ‘camera device’. In particular, the image sensor may be configured to convert incident light into an electrical signal or into a plurality of electrical signals comprising information about a distribution of incident light across the image sensor.

According to at least one embodiment, the picture recording arrangement comprises one or a plurality of light sources, like an LED light source. The at least one light source is configured to illuminate a scene comprising a target to be photographed. In other words, the at least one light source is configured to provide a plurality of illuminated areas, for example, in surroundings of the target.

According to at least one embodiment, the light source comprises a plurality of independently controllable light-emitting units. For example, each light-emitting unit comprises one or a plurality of light-emitting diode, LED, chips for emitting electromagnetic radiation such as light. An intensity of the electromagnetic radiation emitted by each LED can be set independently, for example. In particular, the or each light-emitting diode chip comprises a semiconductor layer stack with a pn-junction for converting an electrical current into electromagnetic radiation.

The light-emitting units can be single-color units, for example, to emit white light, or can be multi-color units, for example, to emit red, green and blue light in an adjustable manner, or can also be units for emitting non-visible radiation like near-infrared radiation. It is possible that all light-emitting units are of the same construction, that is, of the same emission characteristics, or that there are light-emitting units with intentionally different emission characteristics.

According to at least one embodiment, the light source is configured to emit radiation along a plurality of emission directions, in particular along a plurality of non-parallel emission directions during operation. For each one of the emission directions, there is one or a plurality of the light-emitting units. There can be a one-to-one assignment between the emission directions and the light-emitting units. The emission directions are different from each other in pairs so that there are no emission directions being parallel or congruent with each other.

In particular, the light source is configured to emit electromagnetic radiation predominantly along the plurality of emission directions. For example, the light source is configured to emit a collimated light beam along each of the emission directions. For example, the collimated light beam has an intensity maximum along the emission direction. Here and in the following, “collimated electromagnetic radiation” or a “collimated light beam” refers to a light beam that has a beam divergence or an opening angle that is limited by an emission angle width. For example the emission angle width is at most 45°, preferably at most 30°, particularly preferably at most 15°.

For example, the light source is configured to emit electromagnetic radiation into at least three different emission directions. For example, the light source is configured to emit electromagnetic radiation into three, four, six, eight, ten, twelve, sixteen, twenty or another number of different emission directions.

For example, the emission directions are configured such that the light source emits electromagnetic radiation predominantly along a conical surface. In other words, each emission direction is a straight line passing through an apex of the conical surface and through a corresponding second point on the conical surface. The plurality of second points may lie on a circle, an ellipse, or on a closed curve with another shape. For example, each of the light beams emitted along the plurality of emission directions has an intensity maximum on the conical surface.

According to at least one further aspect of the light source, for each of the emission directions, there is at least one of the light-emitting units. For example, each of the plurality of light-emitting units emits collimated electromagnetic radiation along a corresponding emission direction. There can be a one-to-one assignment between the emission directions and the light-emitting units, or there can be two or more light-emitting units per emission direction.

According to at least one further aspect of the light source, an emission angle between an optical axis of the light source and each of the emission directions can be changed during operation of the light source. For example, the optical axis of the light source corresponds to an average or mean emission direction of the light source. In other words, the optical axis of the light source is parallel to a sum over all of the plurality of emission directions. For example, the optical axis corresponds to a symmetry axis of the light source.

In particular, each emission direction can be changed continuously or in discrete steps. For example, the light source emits electromagnetic radiation predominantly along the conical surface and an apex angle of the conical surface can be changed during operation.

For example, using a spherical coordinate system centered at the apex of the conical surface, the optical axis of the light source may form a zenith direction, whereas the emission angle, i.e. the angle between the emission direction and the optical axis of the light source, may correspond to a polar angle. For example, the plurality of emission directions may have different polar angles and/or different azimuthal angles in the spherical coordinate system. The polar angle and/or the azimuthal angle of any number of emission directions may be changed during operation of the light source, for example.

According to an embodiment, the light source comprises the plurality of independently controllable light-emitting units, wherein
the light source is configured to emit electromagnetic radiation along the plurality of non-parallel emission directions during operation,
for each of the emission directions, there is at least one of the light-emitting units,
the emission angle between the optical axis of the light source and each of the emission directions can be changed during operation of the light source.

The light source described herein may be used as an adaptive indirect photo flash that is particularly compact. For example, the light source may be used as a photo flash in a wearable device that has a camera for taking photographs, such as a mobile phone or a smart phone.

A photo flash may be used to illuminate an external object while taking a photograph of said object in low light conditions, for example. In contrast to a direct flash that directly illuminates the object, an indirect flash illuminates the object indirectly via the reflection and scattering of the light emitted by the photo flash off close surfaces, such as walls, floors, ceilings, for example. Indirect flash illumination offers a big advantage in photography by creating lighting conditions that are similar or close to natural lighting conditions. In particular, unnatural shadows or overexposure of the object compared to the background can be avoided by using an indirect flash.

In order to use the indirect flash for different camera zoom states, such as tele zoom or wide angle zoom, and/or different object distances, it is advantageous that the emission angle of the light emitted by the light source, and thus the illumination angle of the object, can be changed or tuned, at least partially. The light source described herein allows to change the emission angle and thus an indirect illumination angle of the object. In particular, changing the emission angle allows to deliver more light to the object, depending on the distance between the light source and the object, and/or on the distance between the light source and the surface from which light is scattered and redirected towards the object, for example. Moreover, the light source may be particularly compact. For example, the light source may emit electromagnetic radiation at an emission angle of 60°, with a tolerance of +5° for example, if the camera is in a wide angle zoom state, or at an emission angle of 40°, with a tolerance±5° for example, if the camera is in a tele zoom state.

The emission angle may also be adjusted depending on a distance between the light source and the object, and/or depending on a distance between the light source and the reflective or scattering surfaces for redirecting the emitted light towards the object. For example, the emission angle may be larger for smaller object distances and the emission angle may be smaller for larger object distances. For example, a 3D time-of-flight (TOF) sensor may be used to obtain a distance between the light source and the object, as well distances between the light source and the reflective or scattering surfaces, such as walls, floors, or ceilings, and to map their orientation, for example. Depending on the distances obtained by the 3D TOF sensor, the emission angles of the light source may be adjusted to optimize the lighting conditions of the object, for example.

According to at least one further aspect, the light source is configured as an indirect photo flash. The light source is configured to indirectly illuminate a scene comprising a target or an object to be photographed, for example. In other words, the light source is configured to provide a plurality of illuminated areas, for example, in surroundings of the object. In particular, at most 10%, preferably at most 5%, and particularly preferably none of the light emitted by the light source directly illuminates the object to be photographed.

According to at least one further aspect of the light source, the emission angle for each emission direction is between 30° and 75°, inclusive. Preferably, the emission angle for each emission direction is between 40° and 60°, inclusive. For example, by using emission angles of at least 30°, a direct illumination of the external object by the light source may be avoided. It is also possible that the emission angle for each emission direction takes values between 0° and 90°, inclusive, for example.

According to at least one further aspect of the light source, an emission angle width for each emission direction is between 5° and 45°, inclusive. Preferably, the emission angle width is between 10° and 30°, inclusive. The emission angle width corresponds to a full angular width at half maximum of an intensity distribution of the emitted electromagnetic radiation along one of the emission directions, for example.

According to at least one further aspect of the light source, the light-emitting units are arranged around the optical axis in a circular manner. The light-emitting units may also be arranged around the optical axis in the form of an ellipse, an oval, a square, a rectangle, or a polygon, for example. For example, the light-emitting units are arranged along a circle, an ellipse, an oval, a square, a rectangle, or a polygon in a plane perpendicular to the optical axis of the light source. Preferably, the optical axis of the light source is at the center of the circular arrangement of the light-emitting units.

For example, the emission direction of each light-emitting unit intersects the optical axis of the light source. In other words, the emission direction of each light-emitting unit is tilted inwards and/or towards the optical axis of the light source. Thereby a particularly compact light source may be formed.

According to at least one further aspect, the light source further comprises a tunable lens with an optical axis parallel to the optical axis of the light source. In particular, an aperture of the tunable lens is arranged such that the electromagnetic radiation emitted by at least some of the light-emitting units, preferably by all of the light-emitting units, passes through the aperture of the tunable lens. For example, light beams emitted by the light-emitting units are preferably not clipped by the tunable lens.

For example, the tunable lens has a tunable shape, and/or a tunable thickness in a direction parallel to the optical axis of the light source. For example, a focal length of the tunable lens can be tuned during operation of the light source. The tunable lens refracts and thereby redirects incident light emitted by the plurality of light-emitting units. Accordingly, the emission angles can be changed during operation of the light source by tuning the shape and/or the thickness of the tunable lens.

According to at least one further aspect of the light source, the tunable lens is a liquid lens comprising an optical liquid, and a flexible and transparent membrane, wherein a shape of the membrane changes depending on an adjustable amount of the optical liquid enclosed by the membrane. The liquid lens can be continuously tuned from a concave to a neutral, e.g. flat, to a convex state, for example.

For example, the liquid lens comprises an optical section and an actuation section. Each section comprises a compartment filled with the optical liquid. The optical liquid is transparent for electromagnetic radiation emitted by the light-emitting units. For example, a refractive index of the optical liquid is larger than a refractive index of ambient air surrounding the liquid lens.

For example, the compartments of the optical section and the actuation section are connected via a pump channel. In particular, each compartment is at least partially enclosed by the flexible membrane. The flexible membrane of the optical section is transparent for electromagnetic radiation emitted by the light-emitting units. By changing the volume of the compartment in the actuation section, for example by pushing and/or pulling on the membrane in the actuation section with an actuator, such as a piezo element or voice coil motor, the amount of optical liquid in the optical section can be changed. Accordingly, the shape and the thickness of the compartment in the optical section can be changed, thereby tuning optical properties of the liquid lens.

The tunability of the liquid lens may be limited by mechanical constraints. Therefore, it may be advantageous that electromagnetic radiation emitted by the light-emitting units is incident on the liquid lens at a non-zero angle of incidence, for example at an angle of 50° with respect to the optical axis of the light source. The liquid lens may be configured to continuously change the emission angle in an angular interval around the angle of incidence, for example between 40° and 60°, inclusive. Alternatively, the electromagnetic radiation emitted by the light-emitting units may be incident on the liquid lens off-center and at a normal angle with respect to a main extension plane of the liquid lens, for example. In other words, the electromagnetic radiation may be emitted parallel to the optical axis of the liquid lens.

With continuous tunability of the emission angle, an optimal indirect illumination for different object distances, different zoom states of the camera, and/or different scattering surface arrangements can be obtained, for example.

According to at least one further aspect of the light source, the emission angle for each emission direction can be changed independently. In other words, the emission angles corresponding to different emission directions can be changed individually. For example, for each emission direction there is an optical element, such as a tunable lens or a tunable mirror, configured for changing the corresponding emission angle during operation.

Alternatively or in addition, for each emission direction there may be two or more corresponding light-emitting units that emit electromagnetic radiation along slightly different directions. By selectively switching the two or more corresponding light-emitting units on or off, the emission angle of the corresponding emission direction can be changed.

According to at least one further aspect of the light source, the emission angle for each emission direction can take at least two discrete values. For example, for each of the at least two discrete values of the emission angle there is a corresponding light-emitting unit that can be switched on or off to change the emission angle of the electromagnetic radiation corresponding to the emission direction. The light source may also comprise N light-emitting units for one, more, or all of the plurality of emission directions, where N≥2 is an arbitrary integer number, such that the emission angle for some or all emission directions can take N discrete values.

For example, at least one light-emitting unit is a segmented or pixelated light-emitting element, such as a segmented or pixelated light-emitting diode, with at least two individually controllable pixels that can emit electromagnetic radiation during operation. The emission angle can be changed by separately turning the pixels on and off, for example.

According to at least one further aspect, the light source further comprises a plurality of individual lenses, wherein each individual lens is configured for collimating the electromagnetic radiation emitted by at least two corresponding light-emitting units, and the at least two light-emitting units are arranged off-centered from an optical axis of the corresponding individual lens. Instead of a plurality of individual lenses, the light source may also comprise a plurality of collimation optics of a different type, such as mirrors, for example.

For example, for each emission direction there is an individual lens and two or more corresponding light-emitting units that are arranged off-centered. Accordingly, light emitted by the two or more off-centered light-emitting units is refracted and redirected by the individual lens into two or more different emission directions. By selectively switching the two or more light-emitting units on or off, respectively, the emission angle of the corresponding emission direction can be changed between two or more discrete values during operation, for example. For example, for each emission direction there are two, three or four light-emitting units that can be used to change the corresponding emission angle between two, three or four discrete values.

It is also possible that one of the at least two light-emitting units is arranged centered at the optical axis of the individual lens, while one or more light-emitting units are arranged off-centered from the optical axis of the individual lens, for example.

For example, the individual lenses are freeform lenses with a shape that is optimized to collimate the electromagnetic radiation of each of the at least two corresponding, off-centered light-emitting units.

For example, there may be one individual lens for two, three or more emission directions. In other words, the two, three or more off-centered light-emitting units emit electromagnetic radiation into two, three or more corresponding emission directions during operation of the light source. Moreover, for each emission direction there may be two or more off-centered light-emitting units to change the emission angle of the corresponding emission direction during operation. Accordingly, the number of individual lenses may be smaller than the number of emission directions and the light source may be particularly compact.

According to at least one further aspect of the light source, the optical axis of each individual lens forms an angle with the optical axis of the light source, and the at least two light-emitting units are arranged in a plane spanned by the optical axis of the light source and the optical axis of the corresponding individual lens. Accordingly, light emitted by the at least two light-emitting units has different emission angles. In other words, the light emitted by the at least two light-emitting units has different polar angles in the spherical coordinate system described above.

Alternatively and/or in addition, the at least two light-emitting units are arranged in a plane perpendicular to the optical axis of the light source. Accordingly, the at least two light-emitting units emit electromagnetic radiation at different azimuthal angles in the spherical coordinate system described above.

According to at least one embodiment of the picture recording arrangement, the radiation emitted into the emission directions is emitted predominantly out of a field of view, FOV, of the image sensor. This can mean that at most 20% or at most 2% or at most 0.2% or none of the electromagnetic radiation emitted by the light source is emitted in the field of view of the image sensor in the intended use of the picture recording arrangement. This may apply, for example, at least at an intended image taking distance between the target to be imaged and the picture recording arrangement. The intended image taking distance is, for example, at least 0.1 m or at least 0.2 m or at least 2 m. Alternatively or additionally, this distance is at most 20 m or is at most 10 m or is at most 5 m.

Further, for example, at most 1% or at most 0.1% or at most 0.01% or none of the electromagnetic radiation emitted by the light source directly reaches the image sensor. In other words, the image sensor is not illuminated by the light-emitting units within the picture recording arrangement.

In particular, light of the light source is directed mainly outside the field of view of the image sensor and then reaches or illuminates the scene indirectly via reflection or scattering of the electromagnetic radiation off surfaces that are at least partially outside the field of view of the image sensor, such as walls, floors, ceilings, or others. The image sensor images the scene that is indirectly illuminated by the light source.

The term ‘light source’ may refer to visible light, like white light or red, green and/or blue light, but can also include infrared radiation, for example, near-infrared radiation in the spectral range from 750 nm to 1.2 μm. That is, along each emission direction visible light and/or infrared radiation can be emitted.

According to at least one embodiment, the light source is for adapting illumination. For example, by the light source a photo flash is provided for taking images. The at least one image to be taken can be a single picture or can also be a series of pictures, like an animated image or a video.

In at least one embodiment, the picture recording arrangement comprises:
an image sensor, and
a light source configured to emit radiation along a plurality of emission directions,
   wherein
the light source comprises a plurality of independently controllable light-emitting units,
for each one of the emission directions, there is at least one of the light-emitting units, and
the radiation emitted into the emission directions is emitted predominantly out of a field of view of the image sensor.

According to a further embodiment, the picture recording arrangement comprises:
the light source as described herein, and
the image sensor, wherein
the electromagnetic radiation emitted by the light source is emitted predominantly out of the field of view of the image sensor.

In particular, all features of the light source are also disclosed for the picture recording arrangement and vice versa.

According to at least one further aspect of the picture recording arrangement, the optical axis of the light source and an optical axis of the image sensor are parallel or almost parallel within manufacturing tolerances. The optical axis of the image sensor is a line of sight of the image sensor and/or is parallel to a direction along the center of the field of view of the image sensor, for example.

The picture recording arrangement described herein is intended to provide better artificial light when taking pictures in particular in a low-light environment with a consumer device such as a mobile phone. Cameras in mobile phones often behave poorly in low-light environment, producing images with a lot of noise. To get a good image exposition, it is common to add artificial light to the scene, by turning on some light sources during image capture.

The nature of this additional light can have a huge impact on the quality of the final picture, and the picture recording arrangement proposes a solution to improve the way to bring light into a low-light scene, in a compact and miniaturized packaging that can fit in small form-factor photographic devices, such as mobile phones or wearables.

The picture recording arrangement at the same time:
provides an adaptive indirect illumination of the scene,
comprises multiple light-emitting units individually addressable,
provides a compact low-profile solution that fits into a small form-factor device, and can be integrated in such a device.

Thus, in the picture recording arrangement described herein, an apparatus capable of generating and individually controlling multiple light segments is integrated in a miniaturized module that can be integrated in a small form-factor device. This may enable high quality photographic applications.

Thus, the picture recording arrangement includes a set of individually addressable light-emitting units, for example, each pointing at a different direction to illuminate the area surrounding the field of view of the camera, that is, of the image sensor. Artificial light is adaptively added to the surrounding area that reflects and/or scatters the light within the scene that is intended to be captured by the camera, therefore adding indirect light to the scene itself. Each light-emitting unit includes at least one radiation emitter that can be individually controlled to adjust its contribution to the illumination of the area surrounding the scene, in order to provide an adaptive illumination to the surrounding area and indirectly to the scene.

An additional optics can be used to modify and control the output beam of the light source, in order to efficiently fulfil the desired photometric specification. It can consist of one or more refractive or reflective element, or any combination thereof. Examples are freeform lenses, reflectors, light guides, total internal reflection, TIR, lenses and prisms.

LED chips are commonly used as radiation emitter in various applications thanks to their characteristics, including indoor illumination and flash photography. In case of an LED source, the light output needs to be both collimated and directed outside the camera FOV. For example, an efficient and compact way to achieve both collimation and beam deflection at wide angles, is to consider a collimating optics such as a collimator, a TIR lens and/or a reflector, and tilt the sub-system source and optics at a certain angle with respect to an exit reference plane, in order to aim at the desired direction.

A rigid-flex printed circuit board allows to assembly and connect several sub-systems, according to the number of flashlights segments desired.

Collimating optics can be used to collimate the LED's output to increase the light intensity at the desired location. By tilting the sub-system source and optics instead of considering an optics capable to provide both collimation and deflection requested, it is possible to achieve higher efficiency and an overall more compact module.

Elements on a rigid-flex printed circuit board, RF PCB, can be assembled by standard production machines, for example, by pick-and-place methods, on a flat configuration and at panel level; after the assembly process, the RF PCB can be snapped and flexible leaves could be bent or modeled in order to place the elements on top of peripheral rigid zones aligned with a different plane with respect to a central rigid zone. Having such elements on a different plane enable an overall height reduction that makes the package suitable for a consumer device module slot.

One exemplary embodiment is realized by means of:
a housing body, for example, made of plastics, optics, for example, plastics refractive elements, a plurality of LED chips as radiation emitting elements, solder paste or conductive adhesive, a bonding layer for lenses and the housing body, an RF PCB.
The RF PCB is constituted by three areas: a central rigid zone, a plurality of flexible protrusions, also referred to as leaves, a plurality of rigid zones at the end of the flexible leaves.
For example, the RF PCB has an internal layout such that the rigid zones at the end of the flexible leaves are connected to the central rigid zone.
The LED chips are attached to the peripheral rigid zones by mean of a conductive adhesive or welding element, like solder paste, wherein the LED chips may be encapsulated.
The lenses are attached, for example, by means of a bonding layer, to the peripheral rigid zones; the lenses are optically and mechanically aligned to the LED chips.
The lenses are attached to the housing body, for example, by mean of another bonding layer.
The housing body is attached to the RF PCB central zone, for example, by means of a further bonding layer.
The flexible leaves are bent and the lenses are attached to the housing body, wherein again a bonding layer can be used.
The product build is ready to be tested and assembled in a device, like a main board.

Some advantages of some of the afore-mentioned aspects are, for example:
Housing body: A moldable component can be used which is thus cheap and designable such as it could be a precise reference for lens assembly and their alignment, for example, with no needs of any active alignment.
Lenses: A moldable component can also be used for the lenses to enable cheap and designable manufacture of them and such as they could provide desired optical output and could include mechanical features for a precise assembly and alignment, for example, with no need of any active alignment. The lenses could be assembled by mean of an assembly machine, for example, by pick-and-place, to the RF PCB.
RF PCB: It can be an element based on composite materials that can permit to electrically and maybe also thermally connect elements attached on top of it by mean of an electrically and maybe also thermally conductive layer. Elements on the RF PCB could be assembled by standard production machines, like a pick-and-place machine, on a flat configuration and at panel level; after the assembly process, the RF PCB could be snapped and the flex leaves could be bent or modeled in order to place the elements on top of the rigid zones aligned with a different plane with respect to the central rigid zone.

An alternative mechanical embodiment can be realized without an RF PCB and using instead:
A plurality of small rigid PCBs: The LED chips and the lenses are attached to each rigid PCB in order to create a sub-assembly.
The sub-assembly can be constituted by a lens, a rigid PCB and an LED chip.
Wires can be used to connect the sub-assembly to a main board.
The main board is used to connect the sub-assembly to the device by mean of the wires; the main board could be used as a mechanical reference for a housing attach process.

As other opto-mechanical solutions, the following can be done:
Collimating optics, like collimators or reflectors, and tilted mechanical mounting, can be used.
Similar to the previous embodiment using an RF PCB, different types of optics but same functionality can be used.
Collimating optics and steering optics including two or more optical elements, either refractive or reflective, can be used, for example, one to collimate the source output and one to redirect the beam.
Collimating and steering optics can be used as single optical element to address both functionalities so that a combined reflector and light guide can be realized in one optical element.
A combination of the above-mentioned solutions can be used.

For flashlight applications, the LED chips' emission spectrum is typically broad and may correspond to white light, but other potential applications might be enabled by considering different colors, controlled in RGB or color temperature, ultraviolet, UV, or infrared, IR, spectral range.
Red, green blue, RGB: The exact color of each light-emitting unit is controlled over a wide range of values that cover the whole gamut.
Correlated color temperature, TCC: Many light sources, including LED chips, emit light on a reduced spectrum from warm to cold white light.
IR: The light-emitting units could also emit radiation in the IR spectral range. In such a system, the camera would preferably also have IR capabilities in order to see the light emitted by the light-emitting units.

Some possible examples of application scenarios for the picture recording arrangement described herein are:
Ambient light preservation:

It is tried to illuminate the scene while preserving the ambient light and the visual mood from the low-light environment. Most of the time, without artificial light, the scene is still weakly illuminated. The human eye is very good at adapting to low luminosity, and it is expected to take a picture that reproduces the world as the human eye saw it, that is, with the same light distribution but with good exposure. In other words, by the light source the ambient light can be amplified while keeping its characteristics like color and direction, so that an image with the same mood but increased brightness can be taken.
Style transfer:

In this case it is tried to transfer the style of an arbitrarily chosen reference image to the image to be shot, by actively optimizing the flash. In this use case, it is considered that the color of the light emitted by each light-emitting unit can preferably also be independently controlled. In other words, the illumination conditions of the reference image are analyzed and the flash of the light source is adjusted to resemble the illumination conditions of the reference image enabling that the reference image and the photo to be taken have the same mood.
Scene relighting:

The idea here is to use the picture recording arrangement to relight the scene to match any specific light conditions selected by a user and not only the ambient light. One application could be in the area of background customization for video conferences, where it is wanted to illuminate a face of a person in a way to match the illumination given by a selected background image, similar to style transfer.
Dynamic visual effects:

Another way of controlling the emitted light is to have permanent illumination instead of a flash. In order to create a specific mood, for video content creation, for example, the light-emitting units can be controlled dynamically to create visual effects such as standing near a campfire or being underwater.
3D reconstruction:

With the picture recording arrangement described herein, for example, a target is sequentially indirectly illuminated from different directions and a series of corresponding measurement pictures is taken. From these measurement pictures, a three-dimensional, 3D, shape of the target can be reconstructed. Thus, 3D reconstruction can be done in a simplified manner by, for example, a mobile device, like a smart phone.

To better understand the advantages of the picture recording arrangement described herein, it is reminded that the main problems of direct flash photography may be: strong reflections, bad shading, overexposure, sharp shadows, dazzling. Taken in mind that the most popular for low-light mobile photography is currently to not use the flash at all and enhance the picture with night mode algorithms, the associated main disadvantages are: motion blur, artifacts.

The use of bouncing light, that is, of indirect lighting, solves many problems of the direct flash. When the light bounces on a surface, it is equivalent to using a by far bigger light source placed on the respective surface; the size of this virtual light being equal to the footprint of the flash on said surface. Using such a light inherently removes strong reflections and sharp shadows.

According to at least one embodiment, orientations of the light source's emission directions relative to the image sensor and relative to one another are fixed. That is, the emission directions do not vary their orientation relative to one another and relative to the image sensor. Further during taking the image, it may be intended that the picture recording arrangement and/or the target are not moved.

According to at least one embodiment, a diameter of the light source is at most 12 cm or is at most 8 cm or is at most 4 cm or is at most 2 cm or is at most 1 cm, seen in top view of the images sensor. Alternatively or additionally, said diameter is at least 4 mm or at least 8 mm. Thus, the light source has, for example, lateral dimensions smaller than that of a mobile phone.

According to at least one embodiment, a thickness of the light source is at most 2 cm or is at most 1 cm or is at most 4 mm, seen in side view or seen in cross-section of the light source in perpendicular with the diameter of the light source. Alternatively or additionally, said thickness is at least 2 mm or at least 3 mm. Thus, the light source has, for example, height dimensions comparable with that of a mobile phone.

According to at least one embodiment, an emission angle between an optical axis of the image sensor and all or a majority or some of the emission directions is at least 30° or is at least 45° or is at least 55°. Alternatively or additionally, this angle is at most 75° or is at most 70° or is at most 65°. Said angle may refer to a direction of maximum intensity of the respective emission direction.

According to at least one embodiment, for all or a majority or some of the emission directions an emission angle width per emission direction is at least 3° or is at least 5° or is at least 15° or is at least 25°. Alternatively or additionally, said angle is at most 45° or is at most 35° or is at most 30°. For example, said angle is between 3° and 30° inclusive. Said angle may refer to a full width at half maximum, FWHM for short.

It is possible that the same emission parameters apply for all the emission directions or that the emission parameters differ between the emission directions.

According to at least one embodiment, there are at least six or at least ten or at least twelve of the emission directions. Alternatively or additionally, there are at most 30 or at most 20 or at most 18 of the emission directions. For example, the number of emission directions is between ten and 16 inclusive.

According to at least one embodiment, positions of the light-emitting units relative to one another are fixed. That is, the light-emitting units cannot be moved relative to one another in intended use of the picture recording arrangement.

According to at least one embodiment, the light-emitting units are arranged in a circular manner, seen in top view of the image sensor. For example, the image sensor may be arranged within the circle the light-emitting units are arranged on.

According to at least one embodiment, the emission directions are oriented inwards. For example, there is a common point of intersection of the emission directions. Otherwise, the emission directions may also point outwards so that there is no crossing or intersecting of emission directions.

According to at least one embodiment, the light-emission units are arranged in a linear, square, rectangular or also random manner.

According to at least one embodiment, the light-emitting units are arranged in one or a plurality of matrices, seen in top view of the image sensor. For example, the at least one matrix is a rectangular matrix. Within the matrix, all fields of the matrix or all fields but one field may be occupied by one of the light-emitting units. A size of the at least one matrix is, for example, at least 3×2 fields.

Other than on a circle or in a matrix, the light-emitting units may also be arranged in a hexagonal grid, for example.

According to at least one embodiment, the picture recording arrangement further comprises a housing body. For example, the housing body is made of a plastics. Preferably, the housing body is opaque for visible light.

According to at least one embodiment, the light-emitting units are separate devices all fixed to the housing body. For example, each light-emitting unit is mounted individually onto the housing body. Thus, each one of the light-emitting units may be in mechanical contact with the housing body.

According to at least one embodiment, the housing body comprises a plurality of recesses. The light-emitting units can be arranged in or at the recesses. For example, the recesses are located in a mounting wall of the housing body. There can be a one-to-one assignment between the recesses and the light-emitting units. In this context, the individual optics assigned to the individual light-emitting units may be regarded as being part of the light-emitting units.

According to at least one embodiment, the picture recording arrangement comprises a housing. The housing is composed of a plurality of housing slices. It is possible that the slices are of identical construction. That is, within the manufacturing tolerances, all the housing slices are of the same shape and material composition. Otherwise, different kinds of housing slices can be combined with each other to form the housing. ‘Different kinds’ may mean that there are housing slices of different shapes and/or materials.

The housing composed of the housing slices may also be referred to as the housing body.

According to at least one embodiment, each one of the housing slices carries one or a plurality of the light-emitting units. It is possible that the housing slices themselves are of identical fashion but carry different kinds of the light-emitting units. Hence, there may be RGB housing slices and monochromatically emitting housing slices combined with each other.

For example, the housing slices are produced by molding and equipped with the light-emitting units by means of a pick-and-place machine.

According to at least one embodiment, the housing slices are separated from one another by a gap. In other words, adjacent ones of the housing slices do not touch one another. The gap can be an air gap or can otherwise be filled with another material like a gasket or an adhesive. Hence, there does not need to be a rigid mechanical connection between the housing slices mediated by the housing slices themselves. For example, the housing slices are separated from one another by air gaps and are collectively arranged on a circuit board that ensures the fixed geometric positions of the housing slices and, thus, of the light-emitting units relative to one another. Otherwise, the housing slices can directly be connected to one another, for example, by means of form-lock features and/or an adhesive.

According to at least one embodiment, the light-emitting units are placed on and electrically connected with mounting strips in a periphery of a common circuit board. The common circuit board can comprise a central part and a plurality of mounting strips emerging from the central part. The central part can be rigid. The mounting strips can each comprise a rigid part and a flexible part, wherein the flexible part is located next to the common circuit board in each case.

According to at least one embodiment, the mounting strips are bent relative to the central part of the common circuit board. The bending can be limited to the flexible part of the mounting strips. Hence, the rigid parts of the mounting strips can be tilted relative to one another and relative to the central part.

According to at least one embodiment, the housing body carrying the light-emitting units is mounted on a plurality of wires. The wires can be of rigid fashion. Thus, the wires may form a basket for receiving the housing body and the light-emitting units.

According to at least one embodiment, the wires are mounted on the common circuit board and are bent so that ends of the wires remote from the common circuit board are arranged in parallel with mounting faces of the light-emitting units, the mounting faces are inclined relative to the common circuit board. For example, each pair of wires is connected to one of the light-emitting units.

According to at least one embodiment, the picture recording arrangement further comprises the common circuit board directly carrying all the light-emitting units. In this case, the light-emitting units can be arranged in parallel with each other on the common circuit board. In other word, all the optical axes of the light-emitting units may be arranged in parallel with one another and the common circuit board can have a flat side carrying all the light-emitting units. Between the light-emitting units and the common circuit board there is only a connection means like a solder, for example.

According to at least one embodiment, some or all of the light-emitting units are followed by redirectional optics for defining the emission directions. That is, the optical axes of the light-emitting units being in parallel with each other are ‘bent’ by the redirectional optics.

According to at least one embodiment, each one of the light-emitting units comprises at least one LED chip. For example, there is exactly one LED chip per light-emitting unit which may provide white light. For example, there are two LED chips per light-emitting unit which may provide independently adjustable white light of different correlated color temperature. For example, there are three LED chips per light-emitting unit which may provide independently adjustable red, green and blue light. For example, there are four LED chips per light-emitting unit which may provide independently adjustable IR radiation and red, green as well as blue light.

According to at least one embodiment, each one of the light-emitting units comprises a reflector for reducing radiation spread following said at least one LED chip. The reflectors are for specular reflection, but may also be for total internal reflection or Lambertian reflection, for example.

According to at least one embodiment, the picture recording arrangement further comprises one or a plurality of common optics elements being optically downstream of all the light-emitting units. For example, the at least one common optics element is a lens or a prism. The common optics element can be a ring or a circular plate attached to the light-emitting units.

According to at least one embodiment, seen in top view of the image sensor, the light-emitting units surround a placement area. For example, in the placement area the at least one image sensor and/or at least one further optoelectronic unit, like a flash for direct lighting, is/are located.

According to at least one embodiment, the light source comprises an additional light-emitting unit configured for direct lighting of the target. The additional light-emitting can be a photo flash. It is possible that said additional light-emitting unit is used in other situations and/or applications than the light-emitting units for indirect lighting. Hence, it is possible that both direct and indirect lighting may be addressed serially or also simultaneously with the picture recording arrangement.

According to at least one embodiment, an intended distance between the picture recording arrangement and the target is at least 0.3 m or is at least 1 m. Alternatively or additionally, said distance is at most 10 m or is at most 6 m or is at most 3 m. In other words, the picture recording arrangement and the target are intentionally relative close to one another.

According to at least one embodiment, the light source is configured to independently emit a plurality of beams having different colors along all or some or a majority of the emission directions. Thus, RGB light may be provided.

According to at least one embodiment, the light source is configured to emit only a single beam of light along at least some of the emission directions. Thus, the light source can have a single, fix color to be emitted. In this case, ‘color’ may refer to a specific coordinate in the CIE color table.

According to at least one embodiment, the light source comprises one or a plurality of emitters for non-visible radiation, like near-IR radiation. It is possible that there is only one common emitter for non-visible radiation or that there is one emitter for non-visible radiation per emission direction.

According to at least one embodiment, the picture recording arrangement comprises a 3D-sensor. By means of the 3D-sensor, the picture recording arrangement can obtain three-dimensional information of the scene. The 3D-sensor can be, for example, based on a stereo camera set-up, on a time-of-flight set-up or on a reference pattern analyzing set-up.

According to at least one embodiment, the picture recording arrangement is a single device, like a single mobile device, including the image sensor as well as the light source and optionally the at least one additional light-emitting unit, the at least one emitter for non-visible radiation and/or the at least one 3D-sensor. For example, the picture recording arrangement is configured to be hold by a single hand of a user.

According to at least one embodiment, the picture recording arrangement is a mobile phone, like a smart phone.

A method for manufacturing a picture recording arrangement is additionally provided. By means of the method, a picture recording arrangement is produced as indicated in connection with at least one of the above-stated embodiments. Features of the picture recording arrangement are therefore also disclosed for the method and vice versa.

In at least one embodiment, the method for manufacturing the picture recording arrangement comprises the following steps, for example, in the stated order:
forming the housing body or the housing,
providing the light-emitting units, and
applying the light-emitting units at the housing body or the housing.

According to at least one embodiment, the housing body or the housing is of one or of a plurality of electrically insulating materials. Said at least one electrically insulating material carries electrically conductive structures, like conductor tracks and/or bond pads.

According to at least one embodiment, the housing body or the housing is a molded interconnect device, MID for short. That is, the housing body or the housing can be manufactured by molding like injection molding or compression molding.

According to at least one embodiment, the electrically conductive structures are formed on the housing or the housing body by laser direct structuring, LDS for short. For example, the housing or housing body is of a thermoplastic material doped with a non-conductive metallic inorganic compound that can be activated by means of laser radiation. A laser then writes a course of a later circuit trace on the thermoplastic material. Where the laser radiation hits the thermoplastic material, the metal additive forms a micro-rough track. The metal additive of this track forms the nuclei for a subsequent metallization, for example, in an electroless copper bath. It is possible that successively layers of, for example, copper, nickel and/or gold finish can be raised in this way.

A light source is additionally provided. The light source is configured for a picture recording arrangement as indicated in connection with at least one of the above-stated embodiments. Features of the picture recording arrangement are therefore also disclosed for the light source and vice versa.

In at least one embodiment, the light source comprises at least six independently controllable light-emitting units, wherein
the light source is configured as a photo flash,
the light source is configured to emit radiation along a plurality of emission directions,
for each one of the emission directions, there is at least one of the light-emitting units, and
a diameter of the light source is at most 4 cm, seen in top view of the light source.

Further, a method for operating a picture recording arrangement is specified herein. In particular, the method is configured to operate a picture recording arrangement as specified above. All features of the picture recording arrangement are also disclosed for the method for operating a picture recording arrangement, and vice versa.

According to at least one aspect, the method for operating a picture recording arrangement comprises a step of recording a series of images under different lighting conditions with the image sensor, such that each image is recorded while electromagnetic radiation is emitted along a single corresponding emission direction. In other words, each image is recorded while electromagnetic radiation is emitted along only one of the plurality of emission directions. Consequently, for each emission direction a separate image is obtained.

According to at least one further aspect, the method for operating a picture recording arrangement comprises a step of determining optimal intensities of the electromagnetic radiation emitted along each of the plurality of emission directions by comparing the recorded series of images with another image recorded by the image sensor under natural lighting conditions. Here and in the following, natural lighting conditions are lighting conditions where the object is not illuminated by the light source. In other words, the light source does not emit electromagnetic radiation under natural lighting conditions. For the comparison, a brightness of the image recorded under natural lighting conditions may be numerically boosted and thus may be noisy, but sufficient to determine the natural lighting conditions, for example. In particular, individual intensities of the electromagnetic radiation emitted by the light source along each of the plurality of emission directions may by optimally adjusted, such that the natural lighting conditions are reproduced as close as possible.

According to at least one further aspect, the method for operating a picture recording arrangement comprises a step of recording an image while the light source emits electromagnetic radiation according to the previously determined optimal intensities of the electromagnetic radiation along each of the emission directions. In particular, the intensity of the electromagnetic radiation emitted by each individual light-emitting unit is adjusted such, that the object is illuminated in a manner as close as possible to the natural lighting conditions. For example, the illumination by the light source avoids unnatural shadows of the object and/or overexposure of the object compared to a background.

According to an embodiment, the method for operating a picture recording arrangement comprises the steps of:
recording the series of images under different lighting conditions with the image sensor, such that each image is recorded while electromagnetic radiation is emitted along a single corresponding emission direction,
determining optimal intensities of the electromagnetic radiation emitted along each of the plurality of emission directions by comparing the recorded series of images with another image recorded by the image sensor under natural lighting conditions,
recording an image while the light source emits electromagnetic radiation according to the previously determined optimal intensities of the electromagnetic radiation along each of the emission directions.

According to a further aspect of the method for operating a picture recording arrangement, the series of images comprises images taken at different emission angles.

According to a further aspect of the method for operating a picture recording arrangement, determining the optimal intensities includes determining an optimal emission angle for each of the emission directions.

According to a further aspect of the method for operating a picture recording arrangement, determining the optimal intensities comprises the step of multiplying each image in the recorded series with a corresponding weight factor. For example, the brightness corresponding to each pixel in the image is multiplied with the weight factor.

According to a further aspect of the method for operating a picture recording arrangement, determining the optimal intensities comprises the step of determining optimal weight factors by minimizing an objective function with respect to all weight factors, wherein the objective function is a metric between the image taken under natural lighting conditions and the linear combination of all images in the recorded series multiplied by the corresponding weight factors. For example, the metric is a sum over mean squared differences between the brightness of each pixel in the image taken under natural lighting conditions and the linear combination of all images in the recorded series multiplied by the corresponding weight factors.

According to a further aspect of the method for operating a picture recording arrangement, determining the optimal intensities comprises the step of setting the optimal intensity along each emission direction to be proportional to the optimal weight factor of the corresponding image in the recorded series.

For example, the picture recording arrangement, the light source and/or the method for operating a picture recording arrangement comprise one or more of the following aspects:

1. A picture recording arrangement comprising:
an image sensor, and
a light source configured to emit radiation along a plurality of emission directions,
   wherein
the light source comprises a plurality of independently controllable light-emitting units,
for each one of the emission directions, there is at least one of the light-emitting units, and
the radiation emitted into the emission directions is emitted predominantly out of a field of view of the image sensor.

2. The picture recording arrangement according to aspect 1,
wherein an emission angle between an optical axis of the image sensor and at least some of the emission directions is between 30° and 75° inclusive,
wherein for at least some of the emission directions an emission angle width per emission direction is between 15° and 45° inclusive.

3. The picture recording arrangement according to any one of aspects 1 or 2,
wherein orientations of the light source's emission directions relative to one another and also relative to the image sensor are fixed.

4. The picture recording arrangement according to any one of aspects 1 to 3,
wherein there are at least six and at most 30 of the emission directions and corresponding light-emitting units.

5. The picture recording arrangement according to any one of aspects 1 to 4,
wherein the light-emitting units are arranged in a circular manner, seen in top view of the image sensor.

6. The picture recording arrangement according to aspect 5,
wherein the emission directions point inwards and there is a common point of intersection of the emission directions.

7. The picture recording arrangement according to any one of aspects 1 to 4,
wherein the light-emitting units are arranged in a matrix, seen in top view of the image sensor.

8. The picture recording arrangement according to any one of aspects 1 to 7,
further comprising a housing body,
wherein the light-emitting units are separate devices all fixed to the housing body,
wherein the housing body comprises a plurality of recesses the light-emitting units are arranged at.

9. The picture recording arrangement according to any one of aspects 1 to 7,
further comprising a housing,
wherein the housing is composed of a plurality of housing slices of identical construction,
wherein each one of the housing slices carries at least one of the light-emitting units.

10. The picture recording arrangement according to aspect 9,
wherein the housing slices are separated from one another by a gap so that adjacent housing slices do not touch one another.

11. The picture recording arrangement according to any one of aspects 1 to 10,
wherein the light-emitting units are placed on and electrically connected with mounting strips in a periphery of a common circuit board,
wherein the mounting strips are bent relative to a central part of the common circuit board.

12. The picture recording arrangement according to aspect 8,
wherein the housing body carrying the light-emitting units is mounted on a plurality of wires,
wherein the wires are mounted on a common circuit board and are bent so that ends of the wires remote from the common circuit board are arranged in parallel with mounting faces of the light-emitting units, the mounting faces are inclined relative to the common circuit board.

13. The picture recording arrangement according to any one of aspects 1 to 10,
further comprising a common circuit board carrying all the light-emitting units and the light-emitting units being arranged in parallel with each other on the common circuit board,
wherein at least some of the light-emitting units are followed by redirectional optics for defining the emission directions.

14. The picture recording arrangement according to any one of aspects 1 to 13,
wherein each one of the light-emitting units comprises at least one LED chip and a reflector for reducing radiation spread following said at least one LED chip.

15. The picture recording arrangement according to any one of aspects 1 to 14,
further comprising at least one common optics element being optically downstream of all the light-emitting units.

16. The picture recording arrangement according to any one of aspects 1 to 15,
wherein, seen in top view of the image sensor, the light-emitting units surround a placement area in which the image sensor and/or a further optoelectronic unit is located.

17. The picture recording arrangement according to any one of aspects 1 to 16,
wherein the light source is configured to independently emit a plurality of beams having different colors along at least some of the emission directions.

18. The picture recording arrangement according to any one of aspects 1 to 17,
wherein the light source is configured to emit only a single beam of light along at least some of the emission directions.

19. The picture recording arrangement according to any one of aspects 1 to 18,
wherein a diameter of the light source is at most 4 cm, seen in top view of the images sensor.

20. The picture recording arrangement according to any one of aspects 1 to 19,
further comprising at least one of the following:
   an additional light-emitting unit configured for emitting light into the field of view of the image sensor,
   an emitter for non-visible radiation, or
   a 3D-sensor.

21. The picture recording arrangement according to any one of aspects 1 to 20,
wherein the picture recording arrangement is a smart phone,
wherein the light source is configured to emit a photo flash.

22. A light source comprising at least six independently controllable light-emitting units,
wherein
   the light source is configured as a photo flash,
   the light source is configured to emit radiation along a plurality of emission directions,
   for each one of the emission directions, there is at least one of the light-emitting units, and
   a diameter of the light source is at most 4 cm, seen in top view of the light source.

23. A light source comprising a plurality of independently controllable light-emitting units, wherein
the light source is configured to emit electromagnetic radiation along a plurality of non-parallel emission directions during operation,
for each of the emission directions, there is at least one of the light-emitting units,
an emission angle between an optical axis of the light source and each of the emission directions can be changed during operation of the light source.

24. The light source according to aspect 23, wherein
the light source is configured as an indirect photo flash.

25. The light source according to any of aspects 23 or 24,
wherein the emission angle for each emission direction is between 30° and 75°, inclusive.

26. The light source according to any of aspects 23 to 25,
wherein an emission angle width for each emission direction is between 5° and 45°, inclusive.

27. The light source according to any of aspects 23 to 26,
wherein the light-emitting units are arranged around the optical axis in a circular manner.

28. The light source according to any of aspects 23 to 27,
wherein the light source further comprises a tunable lens with an optical axis parallel to the optical axis of the light source.

29. The light source according to the aspect 28, wherein the tunable lens is a liquid lens comprising:
an optical liquid, and
a flexible and transparent membrane, wherein
a shape of the membrane changes depending on an adjustable amount of the optical liquid enclosed by the membrane.

30. The light source according to any of aspects 23 to 29, wherein
the emission angle for each emission direction can be changed independently, and
the emission angle for each emission direction can take at least two discrete values.

31. The light source according to any of aspects 23 to 30, further comprising a plurality of individual lenses, wherein
each individual lens is configured for collimating the electromagnetic radiation emitted by at least two corresponding light-emitting units, and
the at least two light-emitting units are arranged off-centered from an optical axis of the corresponding individual lens.

32. The light source according to aspect 31, wherein
the optical axis of each individual lens forms an angle with the optical axis of the light source, and
the at least two light-emitting units are arranged in a plane spanned by the optical axis of the light source and the optical axis of the corresponding individual lens.

33. A picture recording arrangement comprising,
a light source according to one of aspects 23 to 32, and
an image sensor, wherein
the electromagnetic radiation emitted by the light source is emitted predominantly out of a field of view of the image sensor.

34. The picture recording arrangement according to aspect 33,
wherein the optical axis of the light source and an optical axis of the image sensor are parallel.

35. A method for operating a picture recording arrangement according to any of aspects 33 or 34, comprising the steps of:
recording a series of images under different lighting conditions with the image sensor, such that each image is recorded while electromagnetic radiation is emitted along a single corresponding emission direction,
determining optimal intensities of the electromagnetic radiation emitted along each of the plurality of emission directions by comparing the recorded series of images with another image recorded by the image sensor under natural lighting conditions,
recording an image while the light source emits electromagnetic radiation according to the previously determined optimal intensities of the electromagnetic radiation along each of the emission directions.

36. The method according to aspect 35, wherein
the series of images comprises images taken at different emission angles, and
determining the optimal intensities includes determining an optimal emission angle for each of the emission directions.

37. The method according to any of aspects 35 or 36, wherein determining the optimal intensities comprises the following steps:
multiplying each image in the recorded series with a corresponding weight factor,
determining optimal weight factors by minimizing an objective function with respect to all weight factors, wherein the objective function is a metric between the image taken under natural lighting conditions and the linear combination of all images in the recorded series multiplied by the corresponding weight factors,
setting the optimal intensity along each emission direction to be proportional to the optimal weight factor of the corresponding image in the recorded series.

38. A method for manufacturing a picture recording arrangement according at least to any one of aspects 8 or 9, comprising the following steps:
providing the light-emitting units,
forming the housing body or the housing, and
applying the light-emitting units at the housing body or the housing,
   wherein the housing body or the housing is of at least one electrically insulating material carrying electrically conductive structures.

39. The method according to aspect 38,
wherein the housing body or the housing is a molded interconnect device, MID, and the electrically conductive structures are formed by laser direct structuring, LDS.

40. The picture recording arrangement according to any of aspects 1 to 21, wherein the light source is the light source according to any of aspects 22 to 32.

A picture recording arrangement and a light source described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

In the figures:

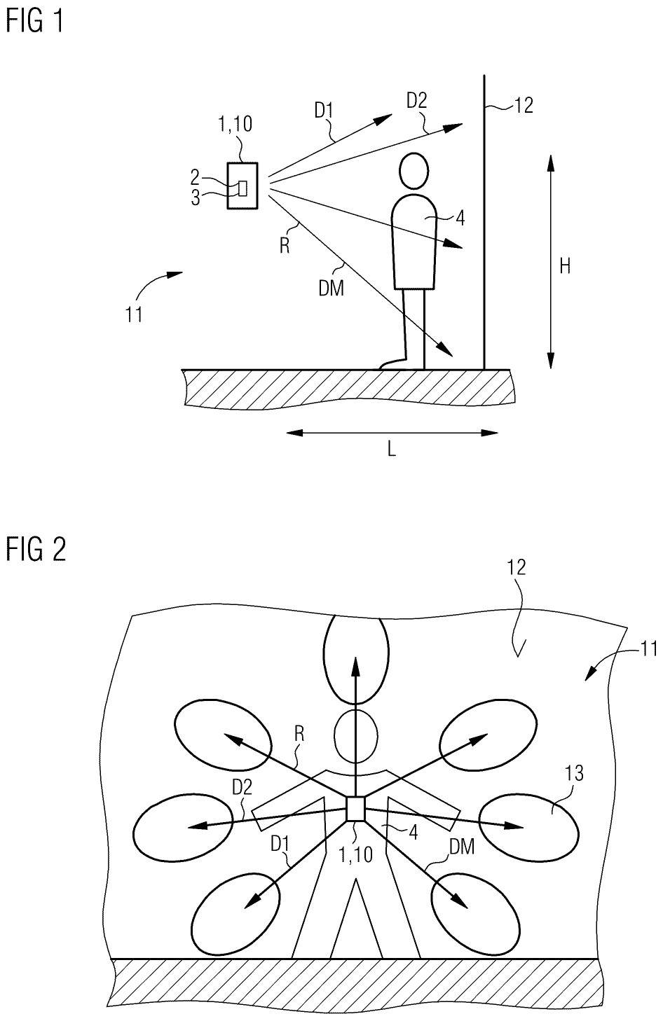

FIG. 1 is a schematic side view of an exemplary application scenario of a picture recording arrangement described herein,

FIG. 2 is a schematic front view of the scenario of FIG. 1,

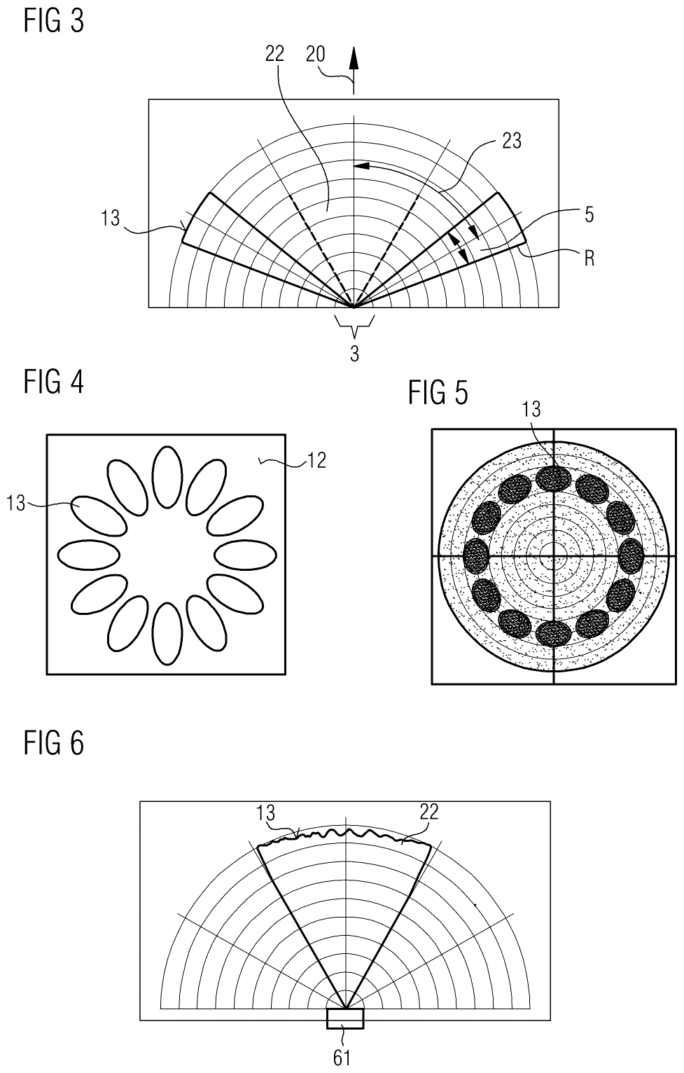

FIG. 3 is a schematic diagram of the emission directions of a picture recording arrangement according to an exemplary embodiment,

FIGS. 4 to 5 are schematic representations of the emission characteristics of a light-emitting unit for exemplary embodiments of picture recording arrangements described herein,

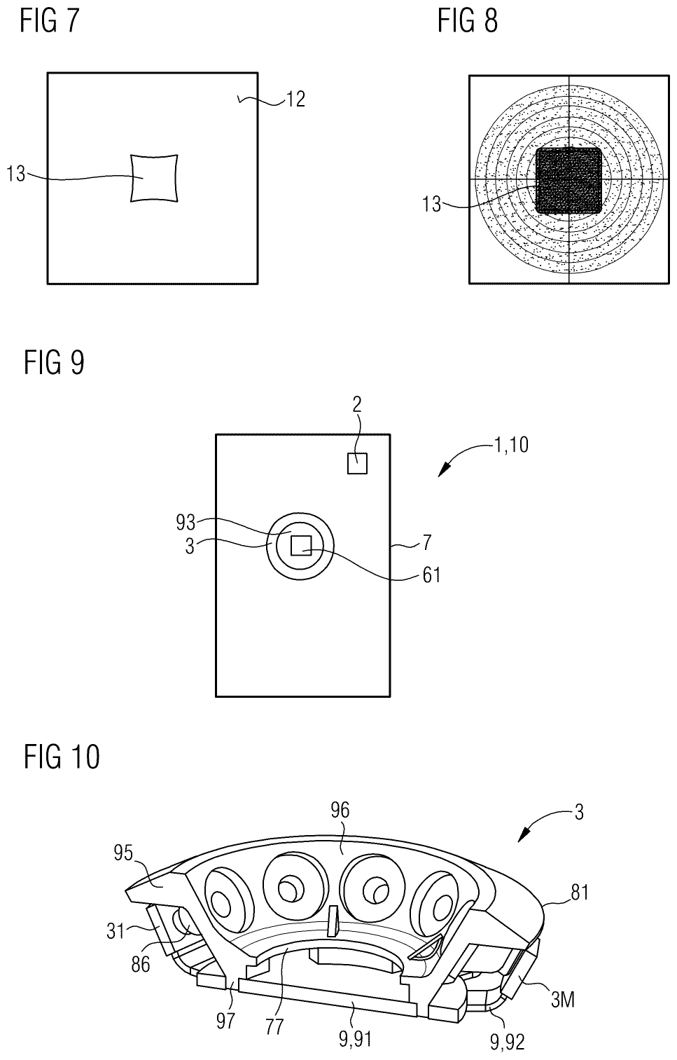

FIGS. 6 to 8 are schematic representations of the emission characteristics of a direct flash light,

FIG. 9 is a schematic top view of an exemplary embodiment of a picture recording arrangement described herein,

FIGS. 10 to 20 are schematic representations of steps for assembling an exemplary embodiment of a picture recording arrangement described herein,

FIGS. 21 to 31 are schematic sectional views and perspective views of optics for exemplary embodiments of light sources for picture recording arrangements described herein,

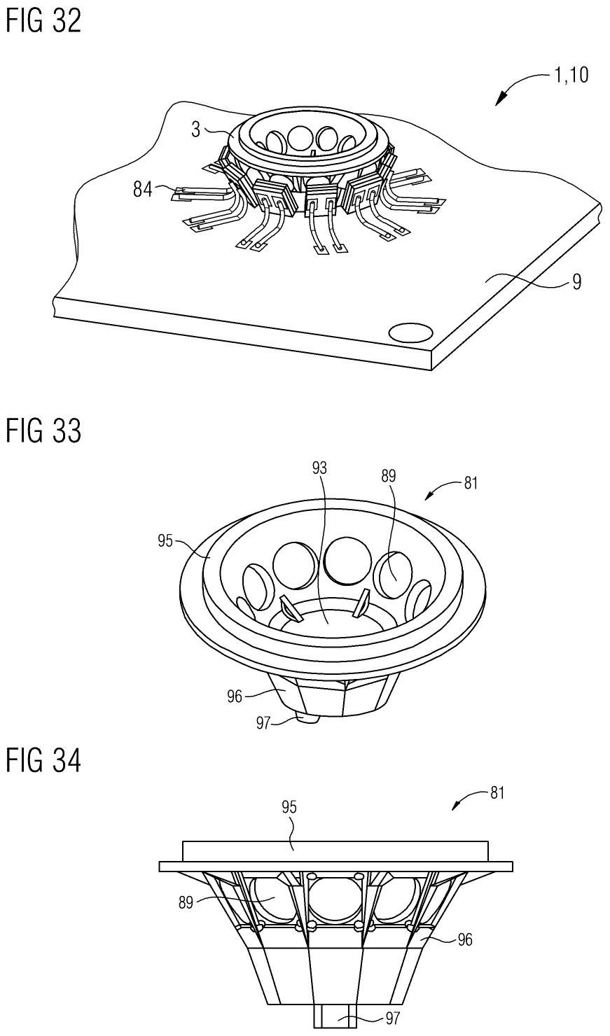

FIGS. 32 to 41 are schematic representations of steps for assembling an exemplary embodiment of a picture recording arrangement described herein,

FIGS. 42 to 46 are schematic top views of exemplary embodiments of picture recording arrangements described herein,

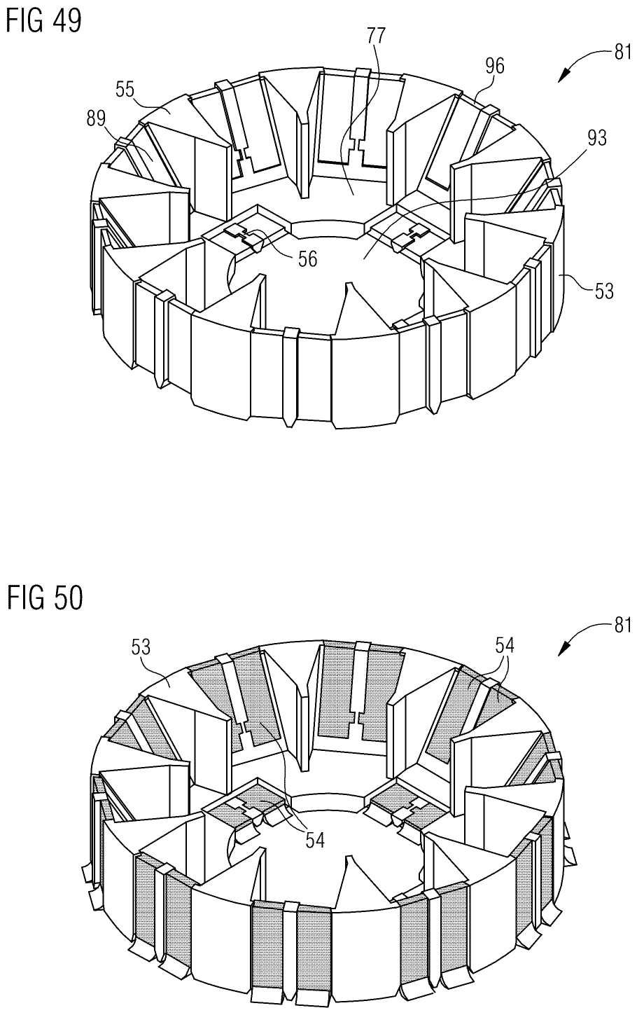

FIGS. 47 and 48 are schematic sectional views of light-emitting units for exemplary embodiments of light sources described herein,

FIGS. 49 to 53 are schematic perspective views of steps for producing an exemplary embodiment of a light source for picture recording arrangements described herein,

FIG. 54 is a schematic side view of another step for the method of FIGS. 49 to 53,

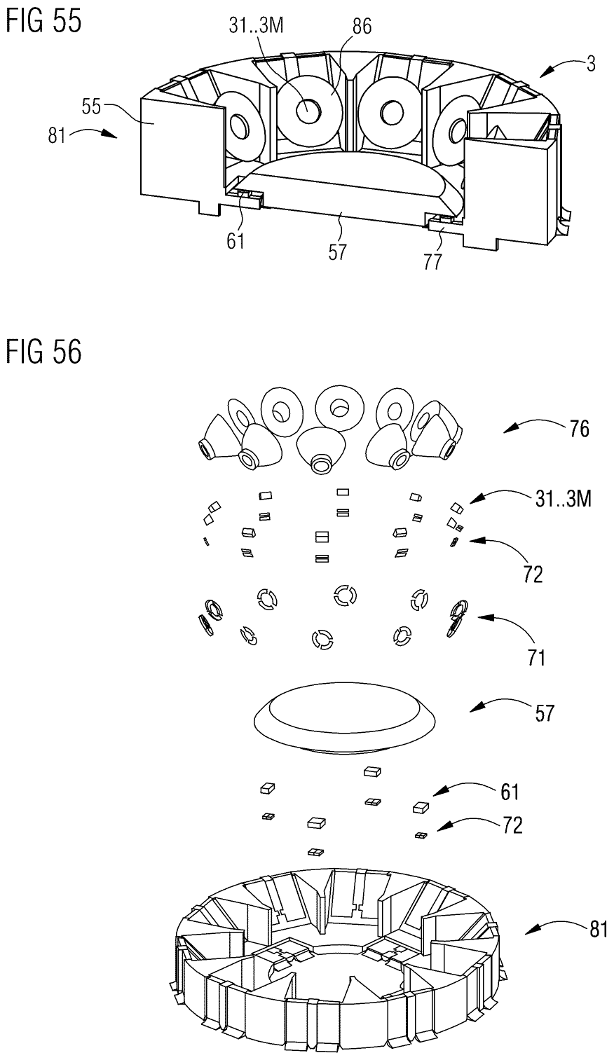

FIG. 55 is a schematic perspective sectional view of the exemplary embodiment of the light source described herein as produced in accordance with FIGS. 49 to 54,

FIG. 56 is a perspective exploded view of the assembling method according to FIGS. 49 to 54,

FIGS. 57 to 59 are schematic perspective views of steps for producing an exemplary embodiment of a light source for picture recording arrangements described herein,

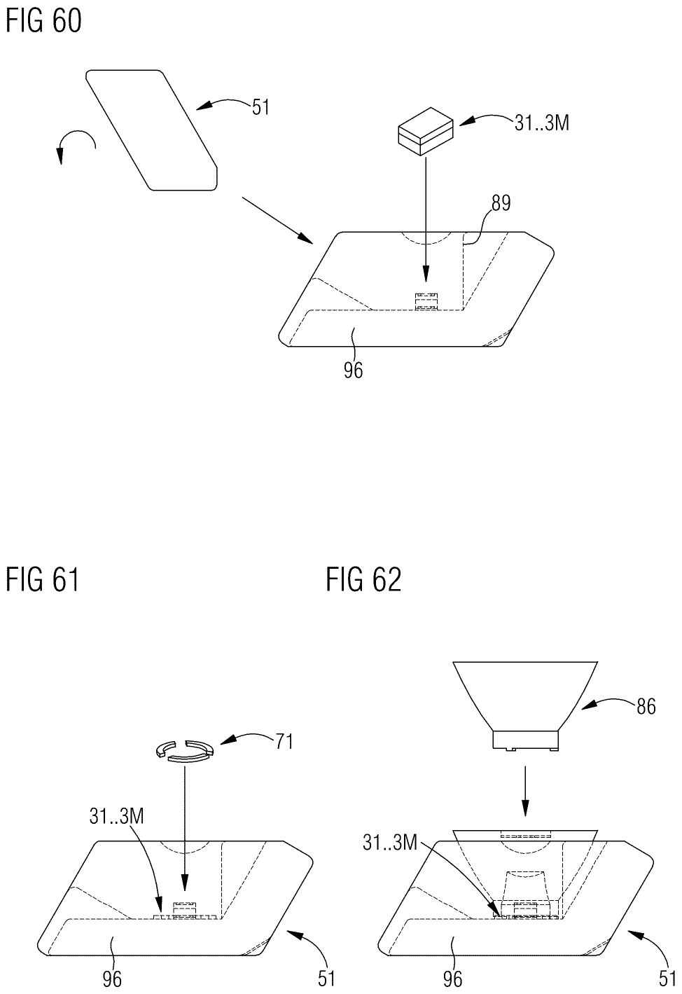

FIGS. 60 to 62 are schematic side views of further steps of the method of FIGS. 57 to 59,

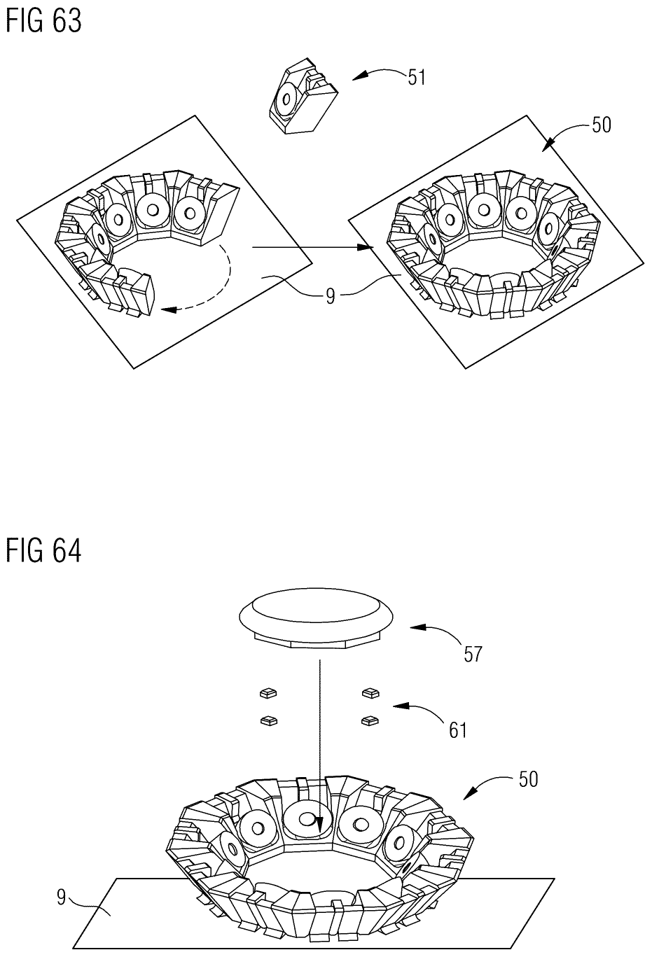

FIGS. 63 and 64 are schematic perspective views of further steps of the method of FIGS. 57 to 62,

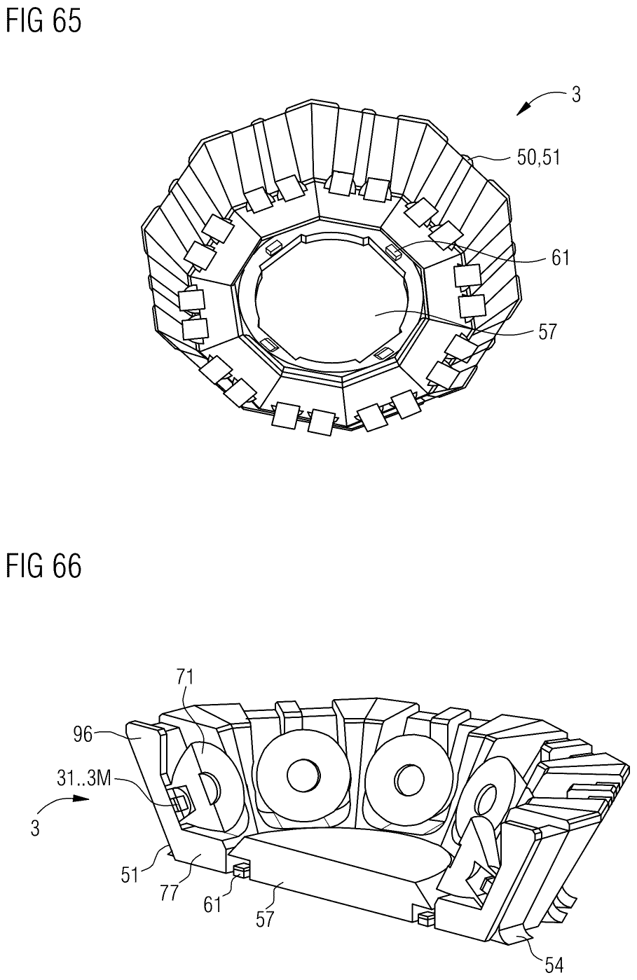

FIGS. 65 and 66 are a schematic perspective view and a perspective sectional view, respectively, of the exemplary embodiment of the light source described herein as produced in accordance with FIGS. 57 to 64,

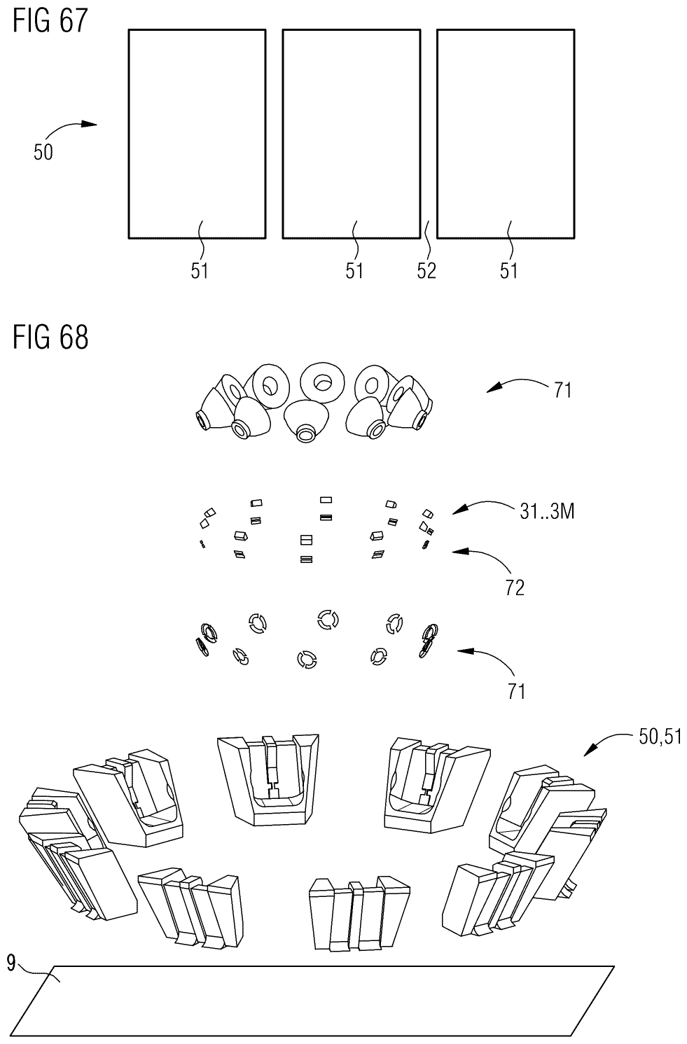

FIG. 67 is a schematic side view of an exemplary embodiment of a housing for picture recording arrangements described herein,

FIG. 68 is a perspective exploded view of the assembling method according to FIGS. 57 to 66,

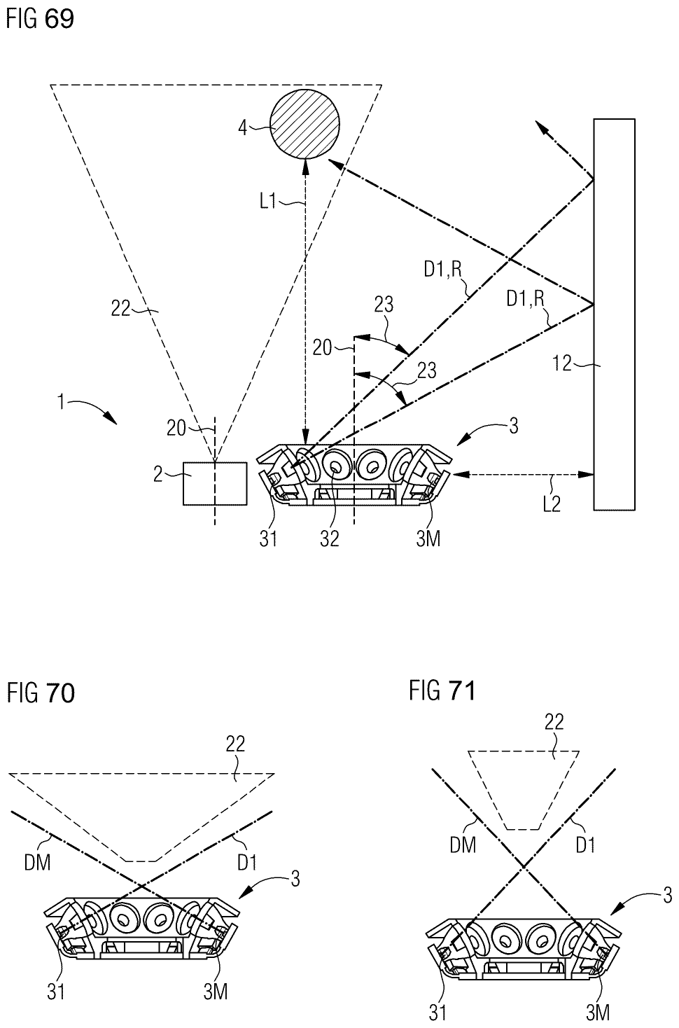

FIG. 69 shows a schematic view of a picture recording arrangement according to an exemplary embodiment,

FIGS. 70 to 73 show schematic views of a light source according to an exemplary embodiment,

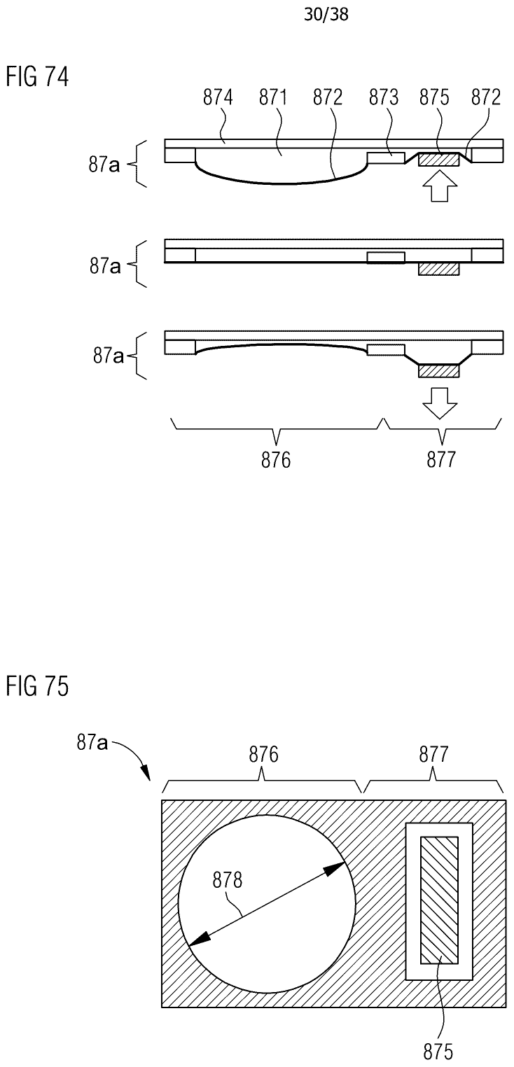

FIGS. 74 and 75 show different views of a liquid lens of a light source according to an exemplary embodiment,

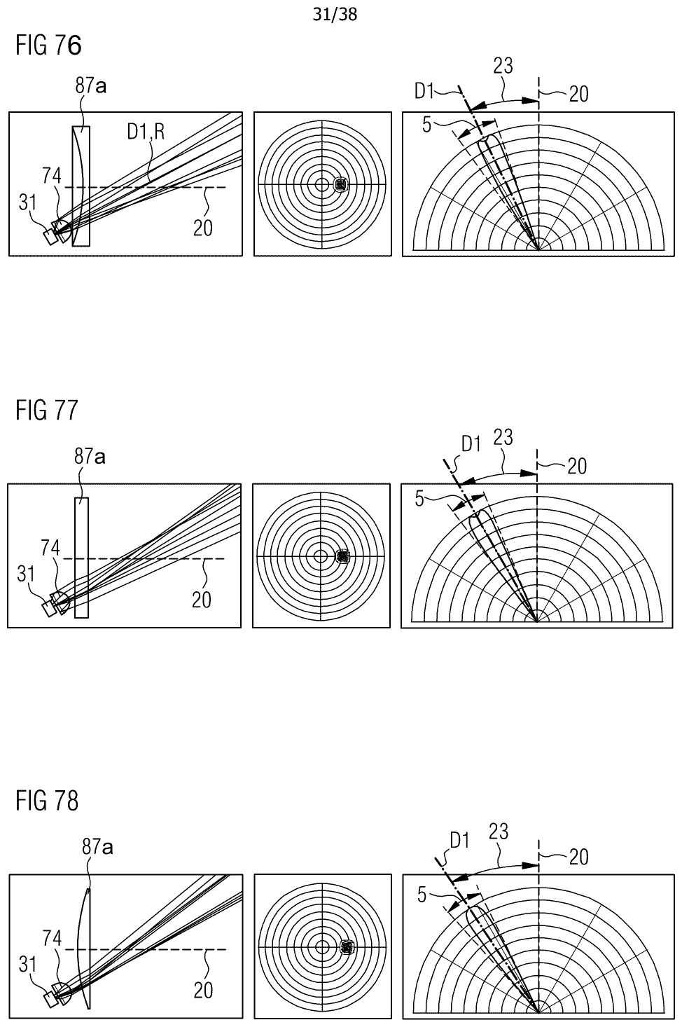

FIGS. 76 to 78 show results of a numerical simulation of electromagnetic radiation emitted by a light source according to an exemplary embodiment,

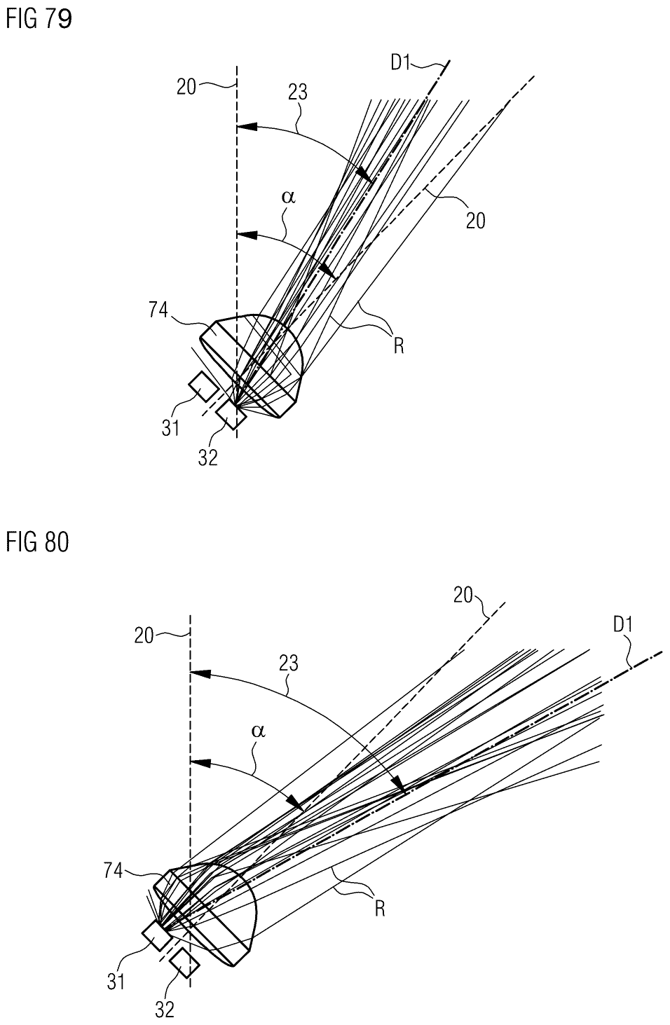

FIGS. 79 and 80 show schematic cross sections of a part of a light source according to a further exemplary embodiment,

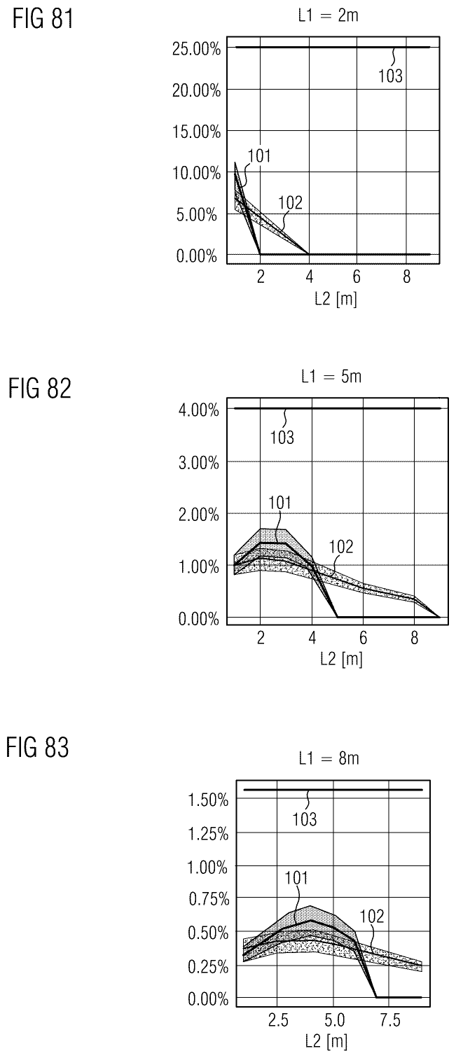

FIGS. 81 to 83 show numerical simulations of an illumination of an external object by a light source according to an exemplary embodiment,

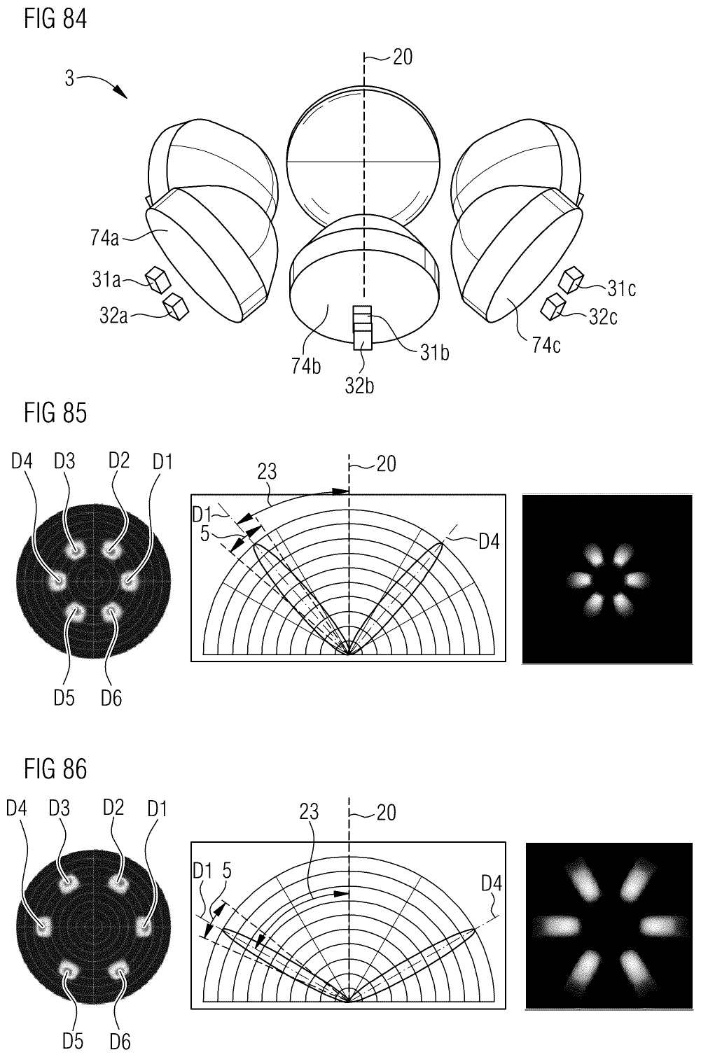

FIG. 84 shows a perspective view of a light source according to a further exemplary embodiment,

FIGS. 85 and 86 show results of a numerical simulation of electromagnetic radiation emitted by a light source according to an exemplary embodiment,

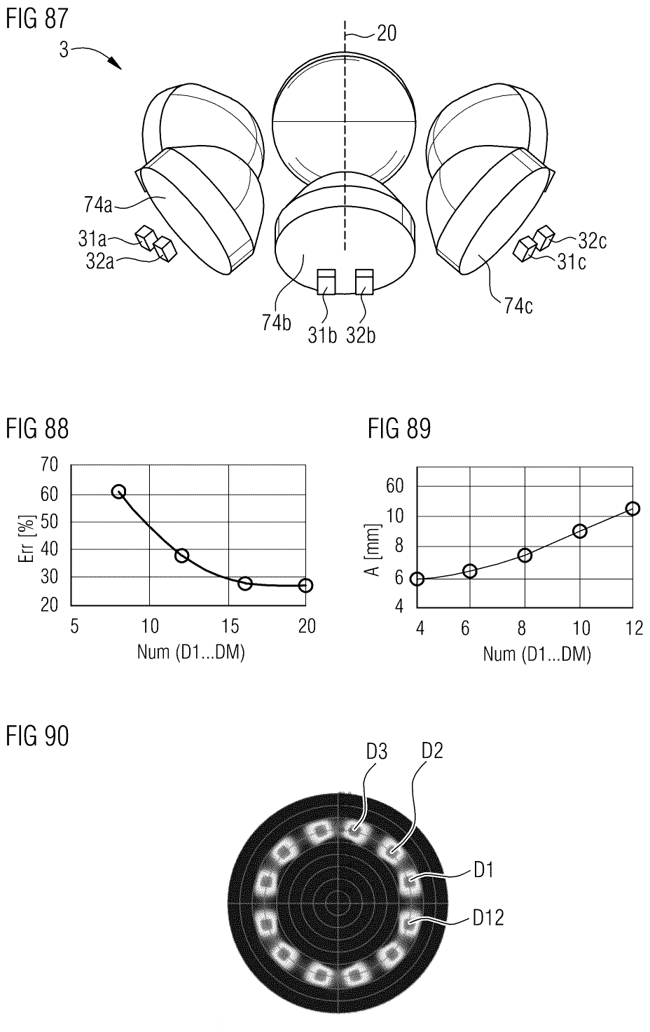

FIG. 87 shows a perspective view of a light source according to a further exemplary embodiment,

FIGS. 88 and 89 show properties of a light source according to an exemplary embodiment,

FIGS. 90 to 94 show results of numerical simulations of electromagnetic radiation emitted by a light source according to different examples,

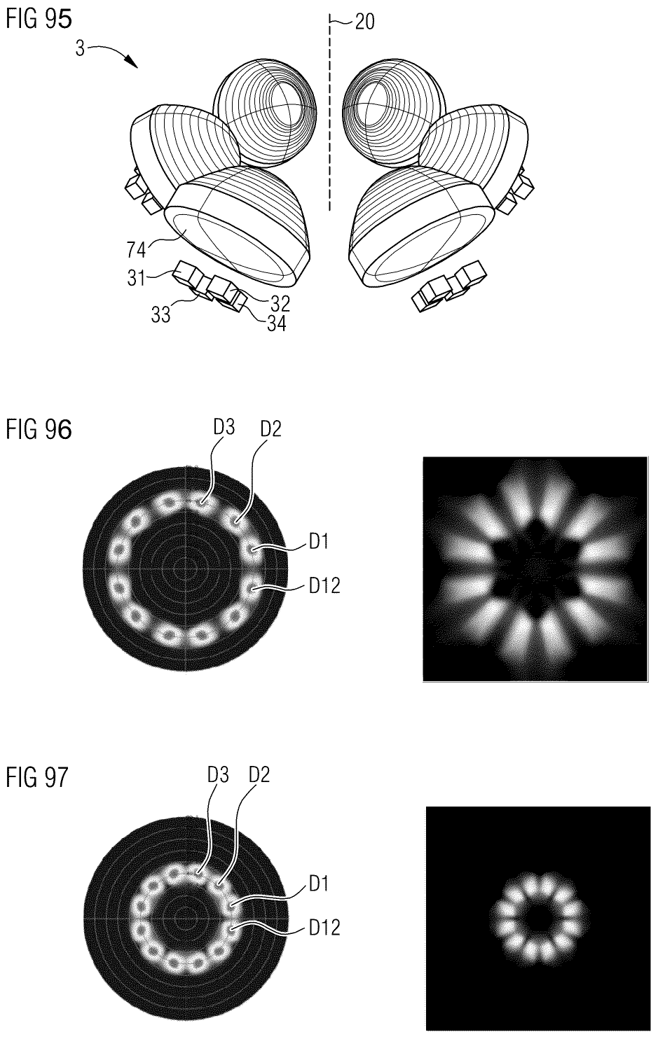

FIG. 95 shows a perspective view of a light source according to a further exemplary embodiment, and

FIGS. 96 and 97 show results of a numerical simulation of electromagnetic radiation emitted by a light source according to a further exemplary embodiment.

FIGS. 1 and 2 illustrate an exemplary embodiment of a picture recording arrangement 1 in an exemplary use scenario. The picture recording arrangement 1 is a mobile device 10 and comprises an image sensor 2 configured to take photos and/or videos. Further, the picture recording arrangement 1 comprises a light source 3. A user of the picture recording arrangement 1 is not shown in FIGS. 1 and 2.

In the intended use, the picture recording arrangement 1 is used, for example, indoors to take a target image of a target 4 in a scene 11. For example, the target 4 is a person or an item or a scenery to be photographed. For example, a distance L between the target 4 and the picture recording arrangement 1 is between 1 m and 3 m. It is possible that a size H of the target 4 is between 1 m to 2 m. The target 4 can be located in front of a wall 12. The target 4 can be directly at the wall or can have some distance to the wall 12.

The light source 3 is configured to emit radiation L, like visible light and/or infrared radiation, along a plurality of emission directions D1 . . . DM. Thus, there are M emission directions. For example, M is between ten and 20 inclusive. By means of the light source 3, for example, for each one of the emission directions D1 . . . DM one illuminated area 13 is present next to the target 4 out of a field of view of the image sensor 2. Thus, the light source 3 can provide indirect lighting of the target 4. The emission of the radiation R along the emission directions D1 . . . DM can be adjusted by means of a processing unit of the picture recording arrangement 1.

The indirect lighting provided by the light source 3 can be used, for example, for improved lighting while keeping a mood of the scene 11.

In FIG. 3, exemplary parameters of the emission directions D1 . . . DM are illustrated in a polar representation. For example, an angle 23 between an optical axis 20 of the image sensor 2 and the emission directions D1 . . . DM is about 60°. An emission angle width 5 of the emission directions D1 . . . DM may be about 30° in each case. Thus, no or virtually no radiation R is emitted by the light source 3 into the field 23 of view of the image sensor 2.

This is illustrated in more detail in FIGS. 4 and 5 wherein FIG. 5 shows the resulting light spots corresponding to the illuminated areas 13 at the flat wall 12, while FIG. 5 refers to the light spots seen on a sphere. Thus, in FIG. 4 the spots are of about elliptical shape and in FIG. 5 the spots are of circular shape. The most bright areas of the spots are next to the target, see FIG. 4, where the target is not drawn.

FIGS. 6 to 8 correspond to the representations of FIG. 3 to 4 but refer to a flash for direct lighting resulting from an additional light source 61. Thus, an about square area is illuminated which is within the field of view 22 of the image sensor 2.

In FIG. 9, an embodiment of the picture recording arrangement 1 is shown, which is the mobile device 10. A casing houses the processing unit 7 as well as the image sensor 2 and the light source 3 which can be of circular shape seen in top view. For example, the additional light source 61 for the direct lighting flash is located in a circular placement area 93 within the circle made of the light source 3. An exemplary light source 3 for such a mobile device 10 is explained in more detail in the following.

In FIGS. 10 to 20, an example of the light source 3 and an example of a manufacturing method therefore are illustrated.

In the perspective sectional drawing of the light source 3 of FIG. 10, it can be seen that the light source 3 comprises a housing body 81 at which a plurality of light-emitting units 31 . . . 3M are attached. The light-emitting units 31 . . . 3M each comprise an individual reflector 86 and are mounted on a common circuit board 9. For example, the housing body 81 is made of an opaque plastics material which may be pigmented or dyed.

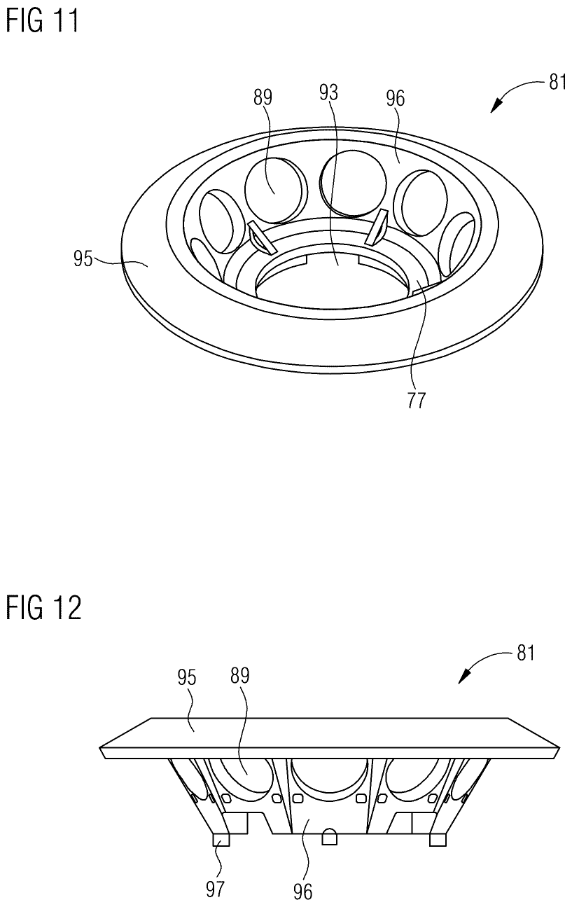

The housing body 81 is shown in more detail in the perspective top view of FIG. 11 and in the side view of FIG. 12. Seen in top view, the housing body 81 is of circular shape and has a diameter of about 12 mm. A height of the housing body 81 is around 3.4 mm. At a top side, the housing body 81 has a continuous rim 95. The rim 95 may be of trapezoidal shape, seen in top view. The rim 95 is atop a mounting wall 96. Seen in top view, compare also FIG. 10, the rim 95 may completely cover the light-emitting units 31 . . . 3M so that a maximum diameter of the light source 3 is defined by the rim 95.

Seen in cross-section, the mounting wall 96 increases in diameter towards the rim 95. Thus, the mounting walls 96 run in an inclined manner, for example, like an envelope of a cone or of a pyramid. In the mounting wall 96, there is a plurality of recesses 89, for example, ten recesses 89. The recesses 89 are spread along the mounting wall 89 equiangularly and at a constant height.

At a side of the housing body 81 remote from the rim 95, the mounting wall 96 can turn into placement means 97, for example, interlocks or pins. Further, next to the placement means 97 the mounting wall 96 can comprise a ledge 77. It is possible that the ledge 77 completely surrounds a bottom opening that lets space for a placement area 93 of the light source 3.

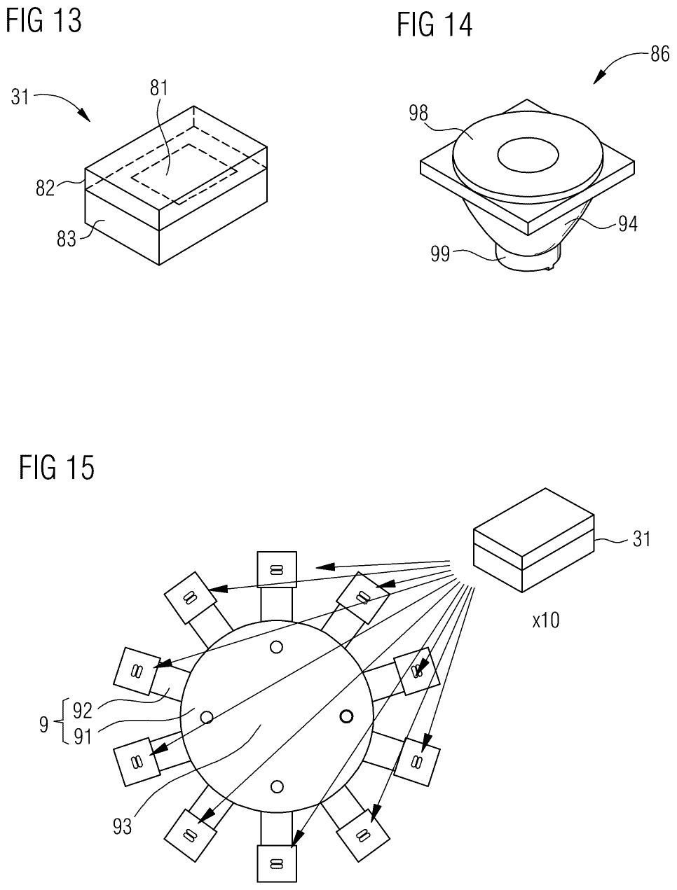

In FIG. 13, an exemplarily light-emitting unit 31 is shown in a perspective view. The light-emitting unit 31 may be of cubic shape. For example, the light-emitting unit 31 comprises an encapsulation body 83 in which an LED chip 81 is embedded. The encapsulation body 83 as well as LED chip 81 are covered by a layer, like a luminescent layer 82 that could comprise at least one phosphor. By means of the luminescent layer 82, for example, blue light emitted by the LED chip 81 can be converted partially into yellow light so that whit light is emitted by the light-emitting unit 31.

Other than shown, the light-emitting unit 31 could also comprise an LED chip for emitting red light, an LED chip for emitting blue light and an LED chip for emitting green light. Further, it is possible that the light-emitting unit 31 comprises an LED chip for emitting near-IR radiation. Thus, the light-emitting unit 31 can comprise, for example, between one and four LED chips. The same applies for all other examples of the light source 3.

In FIG. 14, an exemplarily individual reflector 86 is shown in a perspective view. Optionally, the reflector 86 comprises a connection part 99 which is, for example, of cylinder shape and which is configured to be placed onto the light-emitting unit 31. Further, as the optically most important component, the reflector 96 comprises a reflective wall 94. The reflective wall 94 can be configured for TIR. Thus, the reflector 86 may be of a transparent plastics like polycarbonate or poly(methyl methacrylate), and the reflective wall 94 can be surrounded by a low-refractive index material like air. The reflective wall 94 is for narrowing the emission angle width 5 of the radiation emitted by the at least one LED chip 81 and is, for example, of parabolic shape.

The reflective wall 94 can be followed by a cover part 98 which is, for example, of plane fashion or, other than shown in FIG. 14 also of convex fashion. The cover part 98 may include a round area atop the reflective wall 94 and a square area as a surrounding of the round area, the square area can be configured to improve mounting onto the housing body 81.

In the perspective top view of FIG. 15 it is illustrated that the common circuit board 9 comprises a rigid central part 91 and a couple of mounting strips 92. The mounting strips 92 each comprise a flexible part next to the central part 91 and a rigid mounting part remote from the central part 91. Thus, the common circuit board 9 can be an RF PCB.

On each one of the mounting parts, one light-emitting unit 31 is mounted so that there are, for example, ten mounting parts each bearing one light-emitting unit 31.

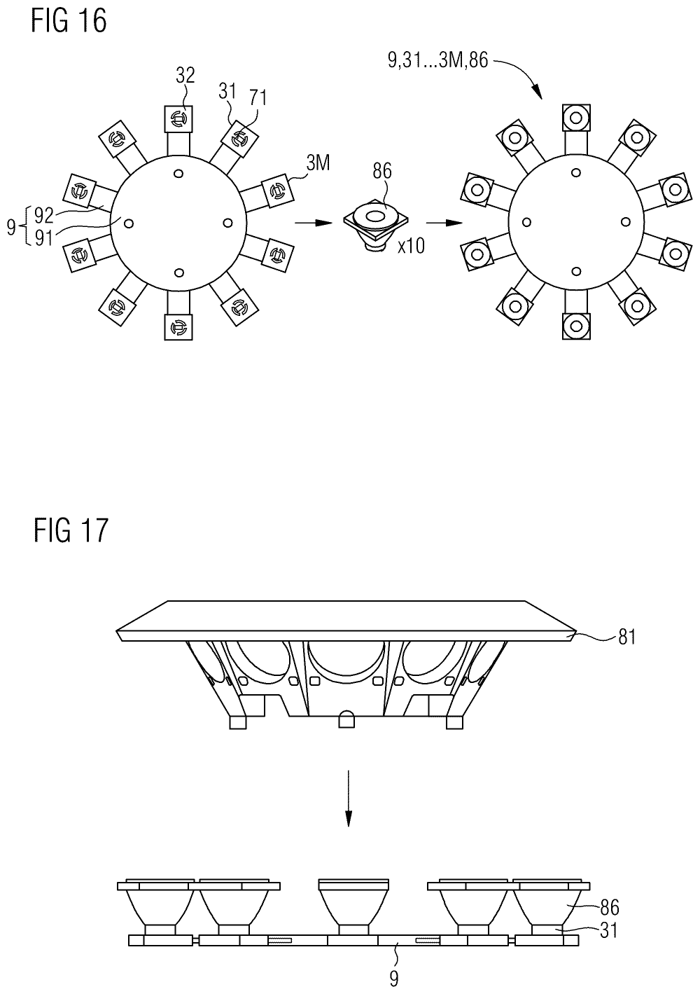

According to the top view of FIG. 16, onto each one of the light-emitting units 31 . . . 3M at the mounting parts one of the individual reflectors 86 is attached.

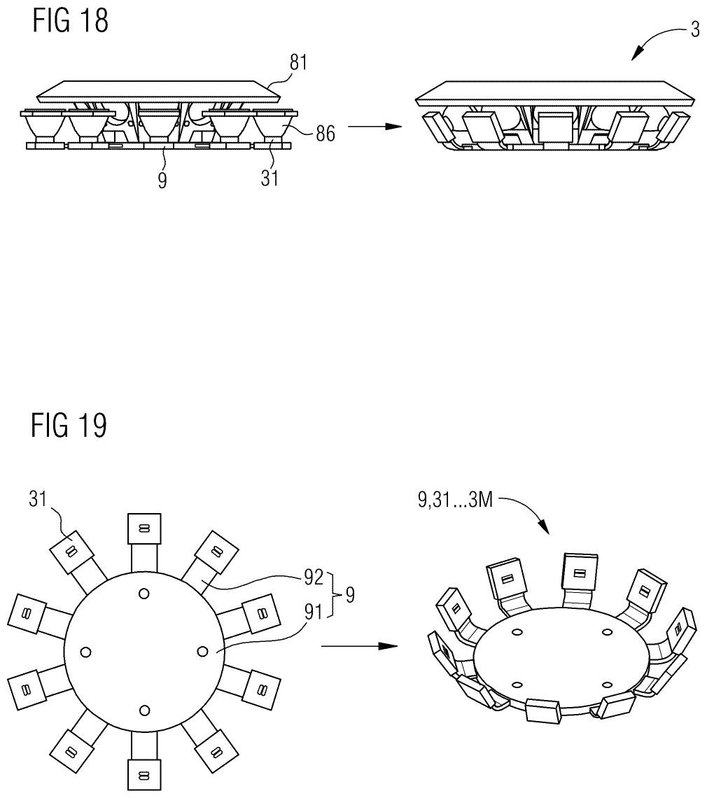

In the side view of FIG. 17 it is illustrated that the housing body 81 is brought onto the central part 91 of the common circuit board 9. Then, see the side view of FIG. 18, the mounting strips 92 are bent so that the individual reflectors 86 get mounted into the recesses 89. Thus, the light source 3 results.

For example, a back side of the common circuit board 9 comprises electric contact faces to electrically connect the light source 3, not shown.

In the perspective top view of FIG. 19 it is shown that alternatively the common circuit board 9 can be bent prior to attaching the housing body 81. Further, not shown, it is possible that the individual reflectors 86 are first mounted onto the housing body 81 and that then the light-emitting units 31 . . . 3M are attached to the individual reflectors 86 and that finally the common circuit board 9 is connected to the light-emitting units 31 . . . 3M. Otherwise, it is also possible that the individual reflectors 86 are mounted onto the housing body 81 and that separately the light-emitting units 31 . . . 3M are attached to the common circuit board 9 and that finally the light-emitting units 31 . . . 3M are connected to the individual reflectors 86.

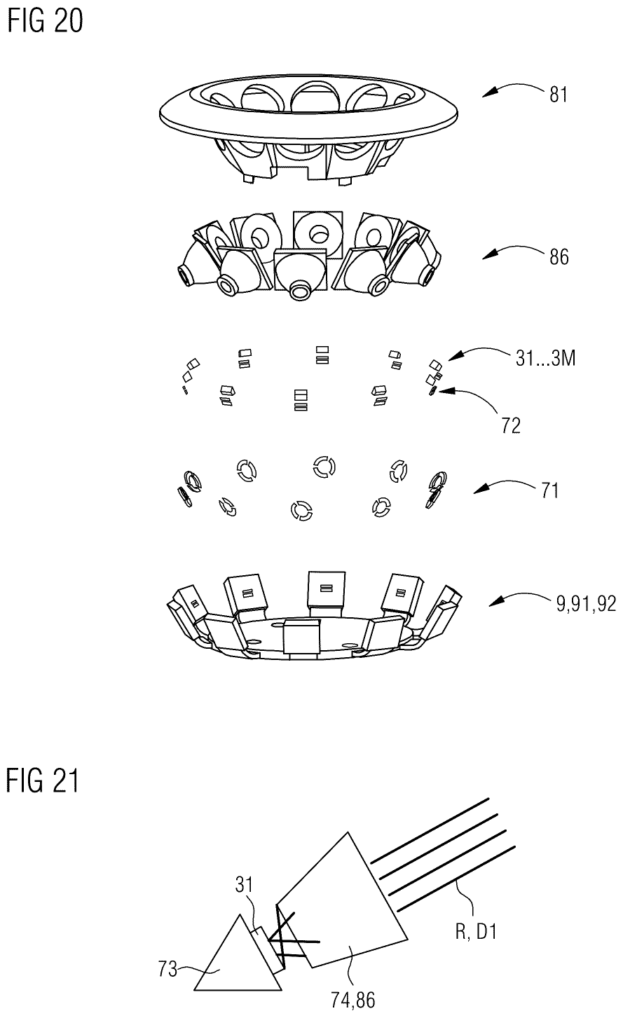

In the perspective exploded view of FIG. 20, the individual components of the light source 3 are illustrated as a summary. Thus, there is the housing body 81 to be connected with the individual reflectors 86, for example, by means of gluing. The light-emitting units 31 . . . 3M are attached to the common circuit board 9 by means of a solder 72, for example, A connection between the light-emitting units 31 . . . 3M and the individual reflectors 86 can be done by means of a bonding material 71, like a solder or a glue.

Otherwise, the same as to FIGS. 1 to 9 may also apply to FIGS. 10 to 20, and vice versa.

FIGS. 21 to 31 illustrate various examples the optics of the light source 3 can be realized, see the schematic side views of FIGS. 21, 25 and 29 as well as the perspective views of FIGS. 22, 23, 24, 26, 27, 28, 30 and 31. The light-emitting units 31 . . . 3M and the associated optics may be arranged in a rotational symmetric manner in each case.

According to FIG. 21, the light-emitting unit 31 is mounted onto a socket 73, like the mounting strips 92 as illustrated in connection with FIGS. 20 to 30. Thus, an emission direction of the light-emitting unit 31 already corresponds to the respectively desired emission direction D1 of the emitted radiation R. Hence, the optics 74, 86 does not need to change an emission direction but need to control the emission angle width 5 only.

This can be achieved by the parabolic individual reflectors 86 working based on TIR, see FIG. 22. These reflectors 86 of FIG. 22 are similar to the reflectors 86 of FIG. 14. However, the reflectors 86 can comprise a central recess at the cover part 98 which may simplify molding of the reflectors 86. Further, there is no need to provide the square area.

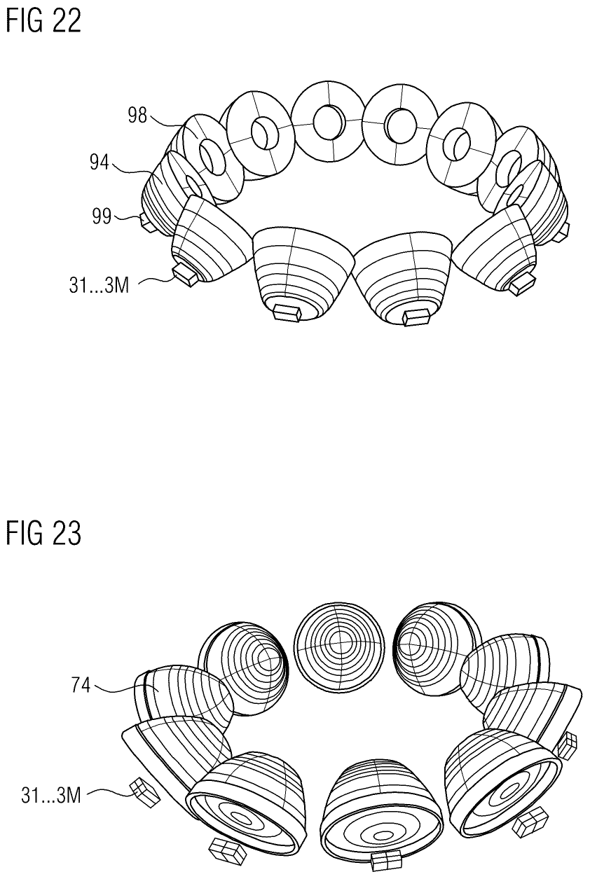

In FIG. 23 it is shown that the optics are individual lenses 74. The lenses 74 can be distant from the light-emitting units 31 . . . 3M. For example, an entrance surface of the lenses 74 next to the light-emitting units 31 . . . 3M has a large radius of curvature or may also be flat. Exit surfaces of the lenses 74 remote from the light-emitting units 31 . . . 3M can be curved by far more strongly and may be of parabolic shape.

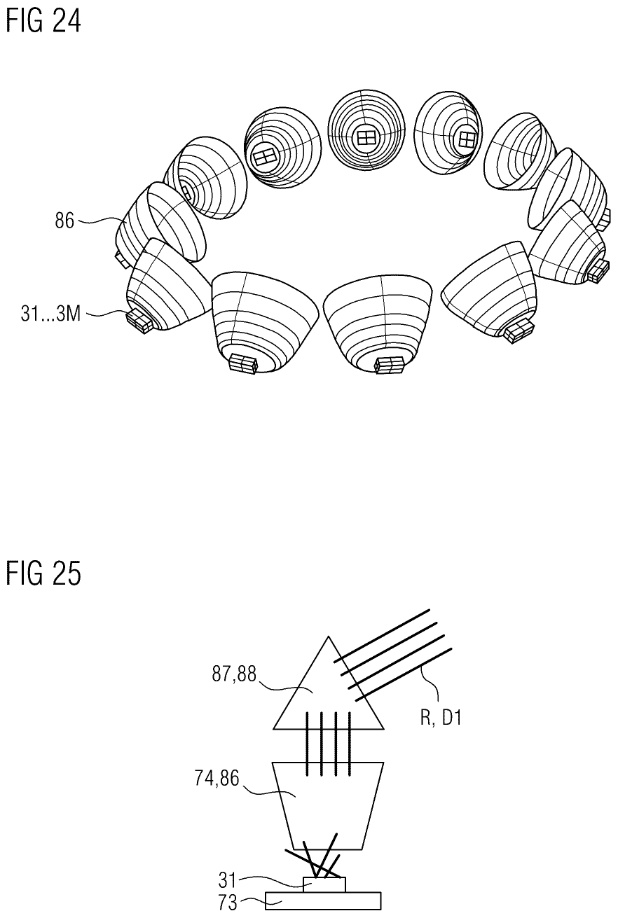

According to FIG. 24, again the individual reflectors 86 are used. In this case, the reflectors 86 work by means of specular reflection and are shaped, for example, in a parabolic manner. Thus, the reflectors 86 can comprise a surface of a cone which is coated with a reflective material like aluminum or silver. An interior of the reflectors 86 can be hollow.

In the concept illustrated in FIG. 25, the light-emitting units 31 . . . 3M are mounted in parallel with each other on a common flat mounting area. Accordingly, the directions the radiation R is emitted by the light-emitting units 31 . . . 3M have to be changed to achieve the desired different emission directions D1 . . . DM. To do so, there can be two different optical elements, a first one 74, 86 to define the emission angle width 5, and a second one 87, 88 to define the emission directions D1 . . . DM.

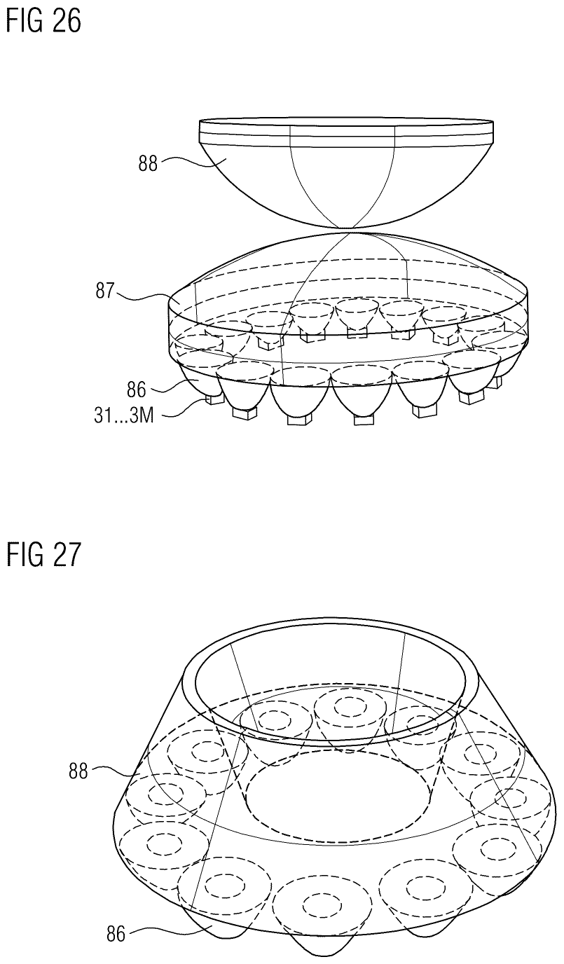

According to FIG. 26, each light-emitting unit 31 . . . 3M is followed by the individual reflectors 86 which can work by TIR or specular reflection, in the same way as explained in FIGS. 14, 22 and 24. As an option, there can be a common optics element 87 covering all the individual reflectors 86. The common optics element 87 is, for example, a plane-convex converging lens. The common optics element 87 and the reflectors 86 can be formed as one piece.

The common optics element 87 is followed by redirectional optics 88. This can be a plane-convex converging lens, too. Because the light-emitting units 31 . . . 3M are placed out of an optical axis of the optics 87, 88, by means of the latter the emission directions D1 . . . DM are defined.

According to FIG. 27, the common redirectional optics 88 is a ring having a triangular cross-sectional area and narrowing in the direction away from the light-emitting units 31 . . . 3M. The emission directions D1 . . . DM can be defined by TIR at an outward wall of the common redirectional optics 88.

The common redirectional optics 88 of FIG. 28 corresponds to that of FIG. 27 but is designed as a Fresnel element in order to reduce the height of the optics.

Further, as an option the placement area 93 can further be provided with optics, like a Fresnel lens. Thus, the placement area 93 may be used for an additional light source 61 like a photo flash for direct lighting.

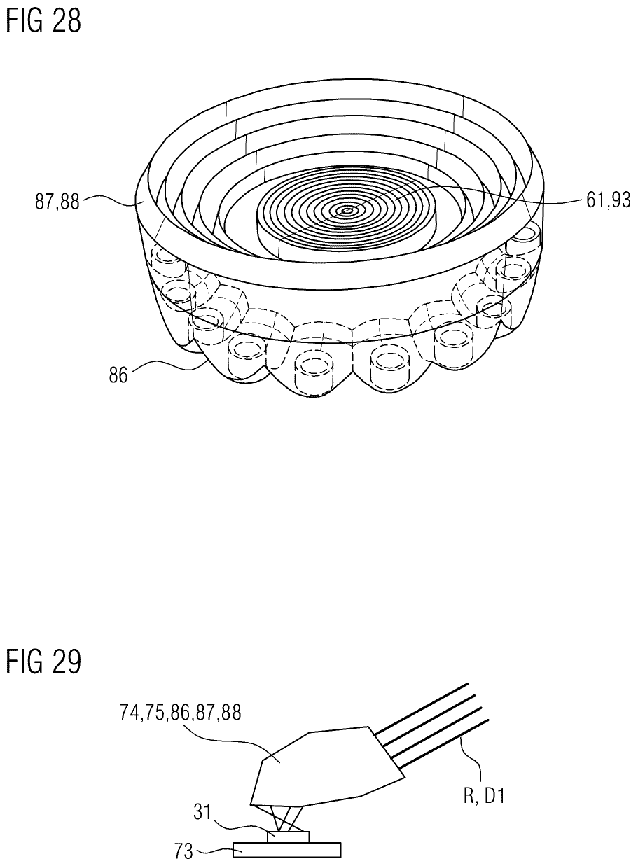

In the concept illustrated in FIG. 29, both functions, that is, reducing the emission angle width 5 and defining the emission directions D1 . . . DM is done by a single optical element. Otherwise, FIG. 29 corresponds to FIG. 25.

According to FIG. 30, the individual reflectors 86 are used. For example, next to the light-emitting units 31 . . . 3M the reflectors 86 comprise a kinked part mainly responsible for redirecting the radiation R, followed by a parabolic part for controlling the emission angle width 5. As illustrated in FIG. 30, the reflector 86 is based on specular reflection, compare also FIG. 24, but a reflector based on TIR may likewise be used.

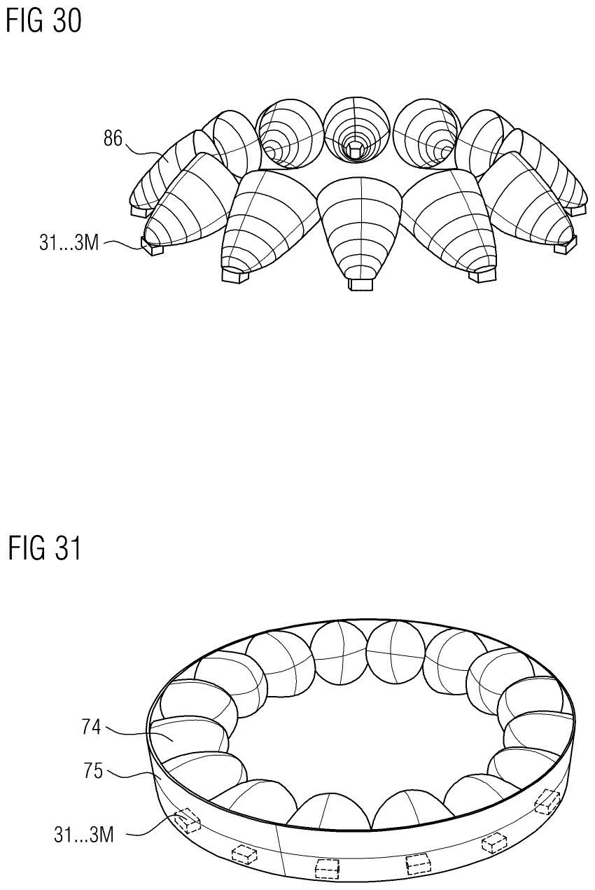

In FIG. 31 it is shown that there is one piece of optics composed of the individual lenses 74 and a common reflective wall 75. The reflective wall 75 can reflect specularly so that a reflective coating may be present or can reflect based on TIR. The lenses 74 are freeform lenses, for example.

The different approaches illustrated in FIGS. 21 to 31 can of course be combined with each other, depending on the actual application, so that emphasis can be laid on cost-efficiency, that is, simple manufacture and adjustment, or on precision or on small required volume, for example.

Otherwise, the same as to FIGS. 1 to 20 may also apply to FIGS. 21 to 31, and vice versa.

In FIGS. 32 to 41, another example of the light source 3 is illustrated, similar as in FIGS. 10 to 20. The housing body 81, the light-emitting units 31 . . . 3M and the reflector 86 may be configured as described above.

In the perspective view of FIG. 32 it is shown that the light source 3 is located on a plurality of bent wires 84 at the common circuit board 9. That is, the wires 84 may form a basket to receive the light source 3.

In the perspective top view of FIG. 33 and the side view of FIG. 34, the housing body 81 is shown. The mounting wall 96 may become steeper in a direction away from the rim 93 in order to improve receipt of the housing body 81 by the wires 84. Thus, there is no need for any ledge, but the mounting wall 96 may extent comparably far away from the rim 93 relative to the recesses 89.

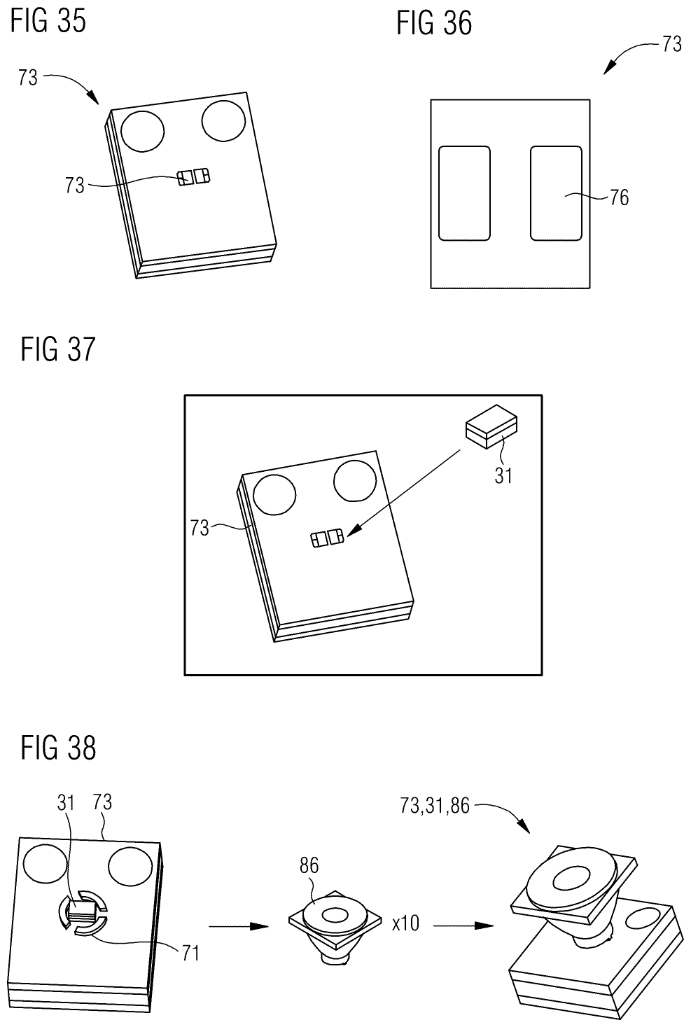

In the perspective top view of FIG. 35 and the bottom view of FIG. 36 the socket 73 for the light-emitting unit 31 is illustrated. The socket 73 is a small rigid plate, like a PCB or a ceramic board comprising connection areas 76 configured, for example, for soldering.

In the perspective top view of FIG. 37 it is shown that the light-emitting unit 31 is mounted onto the socket 73.

According to the top perspective view of FIG. 38, the reflectors 86 are mounted onto the sockets 73 thus covering the respective light-emitting unit 31.

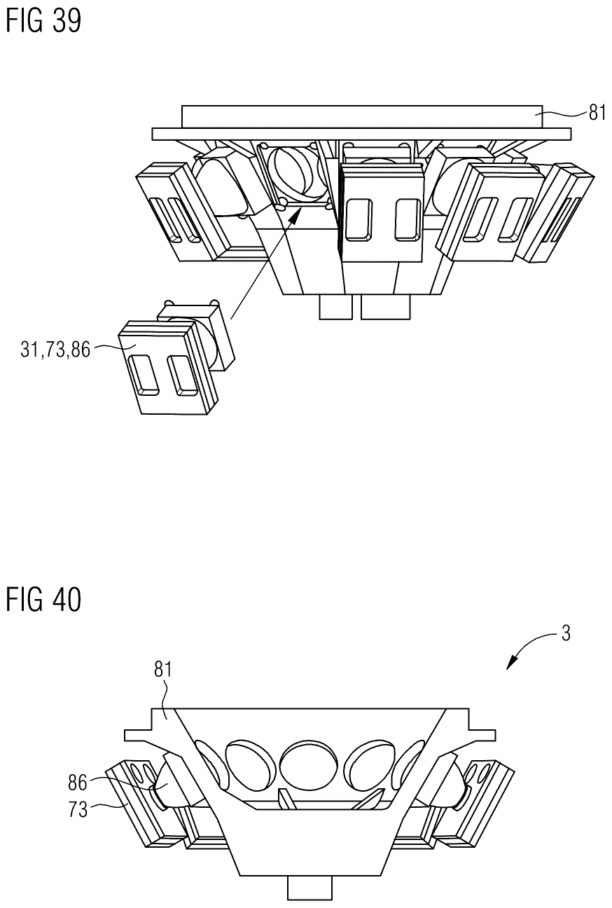

In the perspective side view of FIG. 39 it is shown that the sockets 73 carrying the light-emitting units 31 . . . 3M and the reflectors 86 are attached to the housing body 81. Hence, the light source 3 is finished, see the perspective sectional view of FIG. 40.

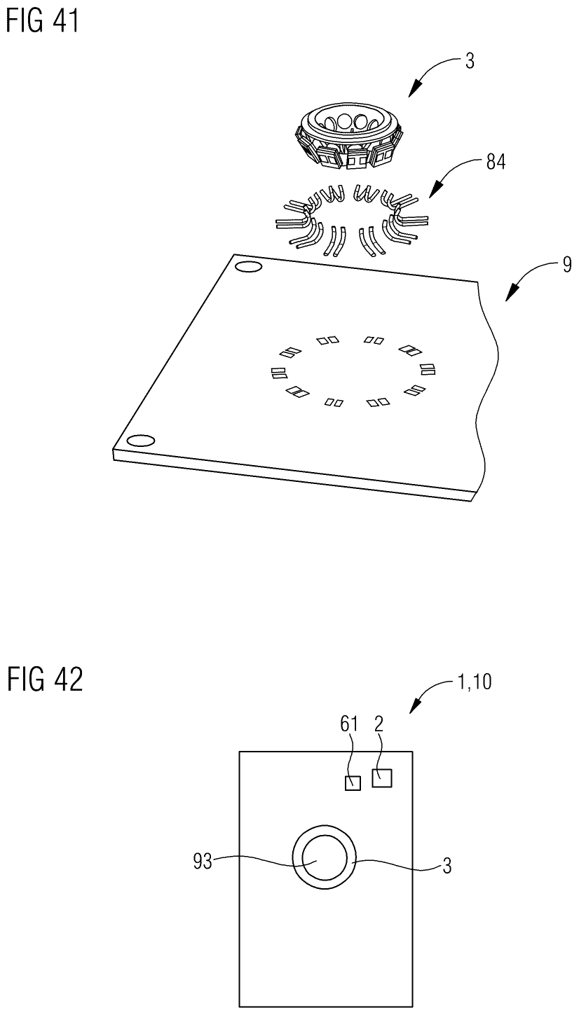

In the perspective exploded view of FIG. 41 it is shown that the light source 3 of FIG. 40 is attached to the wires 84 which are previously bent and which are preferably of spring-like fashion so that minor irregularities can be compensated for during attachment of the light source 3. Prior or even after connecting the wires 84 with the light source 3, the wires 84 are bonded onto the common circuit board 9, for example, by means of soldering. The common circuit board 9 may be a main board or an auxiliary board of the mobile device 10 which is, for example, a smart phone.

Otherwise, the same as to FIGS. 1 to 30 may also apply to FIGS. 31 to 41, and vice versa.

In FIGS. 42 to 46, exemplary embodiments of the picture recording arrangement 1 are shown. In all these cases, the picture recording arrangement 1 is a mobile device 10, like a smartphone, similar to FIG. 9.

The light source 3 comprises the plurality of light-emitting units 31 . . . 3M. The light-emitting units 31 . . . 3M can be light-emitting diodes, LEDs for short. It is possible that the light-emitting units 31 . . . 3M are arranged in a circular manner, that is, on a circle.

Because a distance between the light-emitting units 31 . . . 3M is very small compared with a distance between the illuminated areas 13, compare FIG. 2, it is not necessary that an arrangement order of the light-emitting units 31 . . . 3M corresponds to an arrangement order of the illuminated areas 13. Hence, it is alternatively also possible for the light-emitting units 31 . . . 3M to be arranged in a matrix, for example, see FIG. 45.

If the light-emitting units 31 . . . 3M are arranged on a circle, it is possible that the respective emission directions D1 . . . DM associated with the light-emitting units 31 . . . 3M can point inwards, that is, can cross a center of the circle.

Moreover, the picture recording arrangement 1 includes the at least one image sensor 2. Optionally, the picture recording arrangement 1 can include at least one of an additional light-emitting unit 61, like a photo flash for direct lighting, an emitter 62 for non-visible radiation or a 3D-sensor 63. Further, the picture recording arrangement 1 comprises a processing unit 7 configured to perform the method described above. The processing unit 7 can be a main board or an auxiliary board of the picture recording arrangement 1.

According to FIG. 42, the light-emitting unit 61 for a photo flash for direct lighting is placed next to the image sensor 2. Thence, the placement area 93 of the light source 3 may be free of any optoelectronic component.

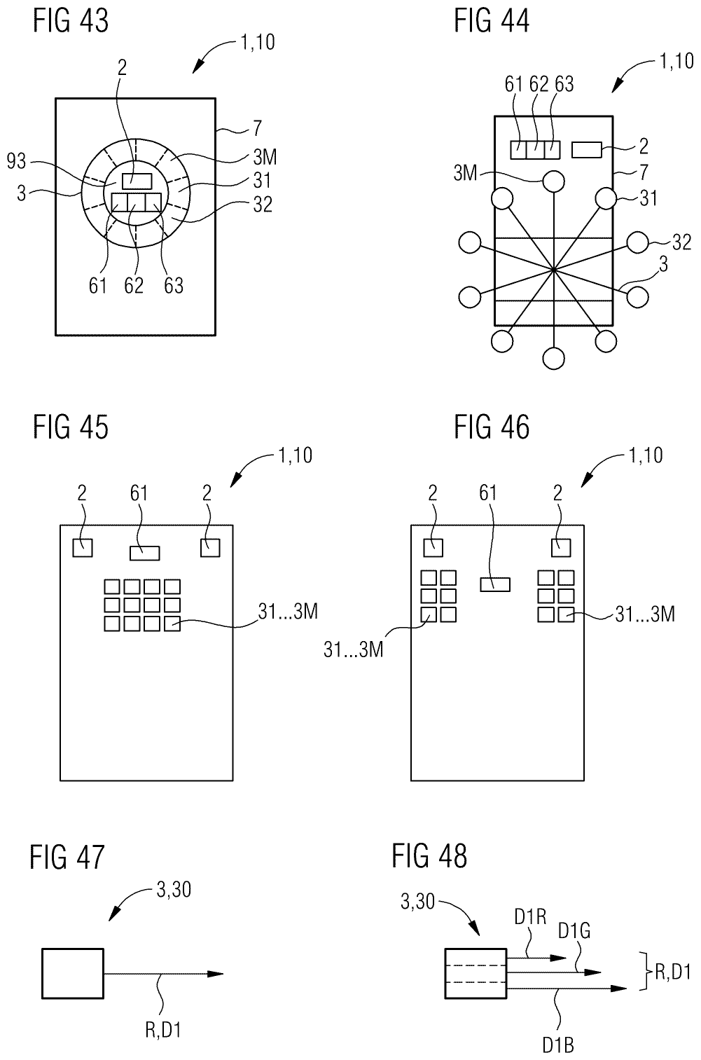

According to FIG. 43, the light source 3 is integrated in a casing of the picture recording arrangement 1. The light-emitting units 31 . . . 3M are arranged around the image sensor 2. Optionally, the at least one of the additional light-emitting unit 61, the emitter 62 for non-visible radiation or the 3D-sensor 63 can also be located within the arrangement of the light-emitting units 31 . . . 3M, seen in top view of the image sensor 2.

Other than shown in FIG. 43, the at least one of the additional light-emitting unit 61, the emitter 62 for non-visible radiation or the 3D-sensor 63 as well as the image sensor 2 can be located outside of the arrangement of the light-emitting units 31 . . . 3M, as illustrated in FIG. 44.

Moreover, in FIG. 44 it is shown that the light-emitting units 31 . . . 3M are arranged in a spider-like manner. In this case, the arrangement of the light-emitting units 31 . . . 3M can protrude from a casing of the picture recording arrangement 1, but it can also be completely within the casing, seen in top view of the image sensor 2 and other than shown in FIG. 44.

Thus, it is possible that the light-source 3 can be an external unit mounted, like clamped or glued, on the casing comprising the image sensor 2. An electrical connection between the casing and the light-source 3 can be done by a USB type C connection, for example.

In FIG. 45 it is further illustrated that the picture recording arrangement 1 can comprise a plurality of the image sensors 2, for example, two of the image sensors 2 which may be located distant from one another. Such a configuration is also possible in all other embodiments.

In FIG. 46 it is illustrated that the light-emitting units 31 . . . 3M does not need to be mounted in a single matrix, but can be spread across multiple matrices, like two matrices.

Further, it is possible that the additional light source 61 for the direct lighting flash is arranged between the matrices. Such a configuration is also possible in all other embodiments.

Otherwise, the same as to FIGS. 1 to 41 may also apply to FIGS. 42 to 46, and vice versa.

In FIG. 47, one exemplary light-emitting unit 31 of the light source 3 is illustrated. In this case, the light-emitting unit 31 has only one channel, that is, is configured to emit along the assigned emission direction D1 with a fixed color, for example. Said color is white light, for example.

Contrary to that, according to FIG. 48 the light-emitting unit 31 comprises three color channels for red, green and blue light, for example, and optionally an additional channel for near-IR radiation. Thus, three beams D1R, D1G, D1B or also four beams if IR is included are emitted along the assigned emission direction D1 to form the radiation R. The three or four color channels are preferably electrically addressable independent of one another so that an emission color of the light-emitting unit 31 can be tuned. For example, each color channel is realized by an own LED chip as the respective light emitter.

The light-emitting units 31 of FIGS. 47 and 48 can be used in all embodiments of the picture recording arrangement 1, also in combination with each other.

Otherwise, the same as to FIGS. 1 to 46 may also apply to FIGS. 47 and 48, and vice versa.

In FIGS. 49 to 56, another exemplary embodiment of a method to produce a light source 3 for picture recording arrangements 1 is illustrated. According to FIG. 49, the housing body 81 is provided. For example, the housing body 81 is a single body produced by molding. Seen in top view, the housing body 81 may be of circular or approximately circular shape. The mounting walls 96 can have inclined inward faces while outward faces are oriented perpendicular to a mounting plane of the housing body 81, for example.

Just as an example, there are ten of the recesses 89 for the light-emitting units 31 . . . 3M to be applied, however, of course there can be more or also less of the recesses 89. For example, between adjacent recesses 89 there is a screen 55.

Seen in top view, the screen 55 can be of trigonal shape and can have side faces running perpendicular to the mounting plane. The screens 55 are to optically separate adjacent recesses from one another. Thus, the housing body 81 is of an electrically insulating material 53, for example, opaque for visible light.

The central placement area 93 which can be of circular or polygonal shape is surrounded by the ledge 77. The ledge 77 can be of disk shape having plane parallel top and bottom sides.

As an option, there are additional recesses 56 in the ledge 77. These additional recesses 56 are configured for additional light-emitting units, not shown in FIG. 49. For example, there are four of the additional recesses 56.

In the method step of FIG. 50, electrically conductive structures 54 are applied directly on the electrically insulating material 53, for example, by means of LDS so that the housing body 81 can be an MID. For example, there are two conductor tracks per recess 89 and per additional recess 56. The conductor tracks for the recesses 89 may run across a top edge of the mounting wall 96 and may then run to the mounting side of the housing body 81. The conductor tracks for the additional recesses 56 may run across an inward side face of the ledge 77 and may then also run to the mounting side of the housing body 81.

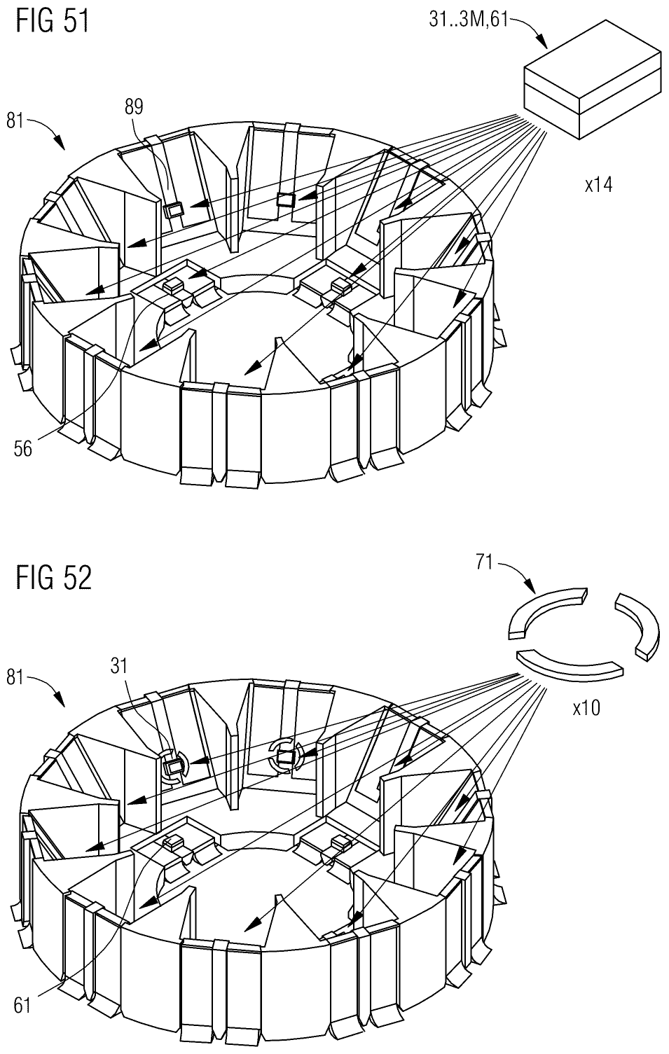

In FIG. 51 it is illustrated that, for example, ten of the light-emitting units 31 . . . 3M and four of the additional light-emitting units 61 are mounted on the conductor tracks in the recesses 89 and the additional recesses 56, respectively.

This is done, for example, by means of soldering with a pick-and-place machine. The additional light-emitting units 61 can be configured as a direct flash light, for example.

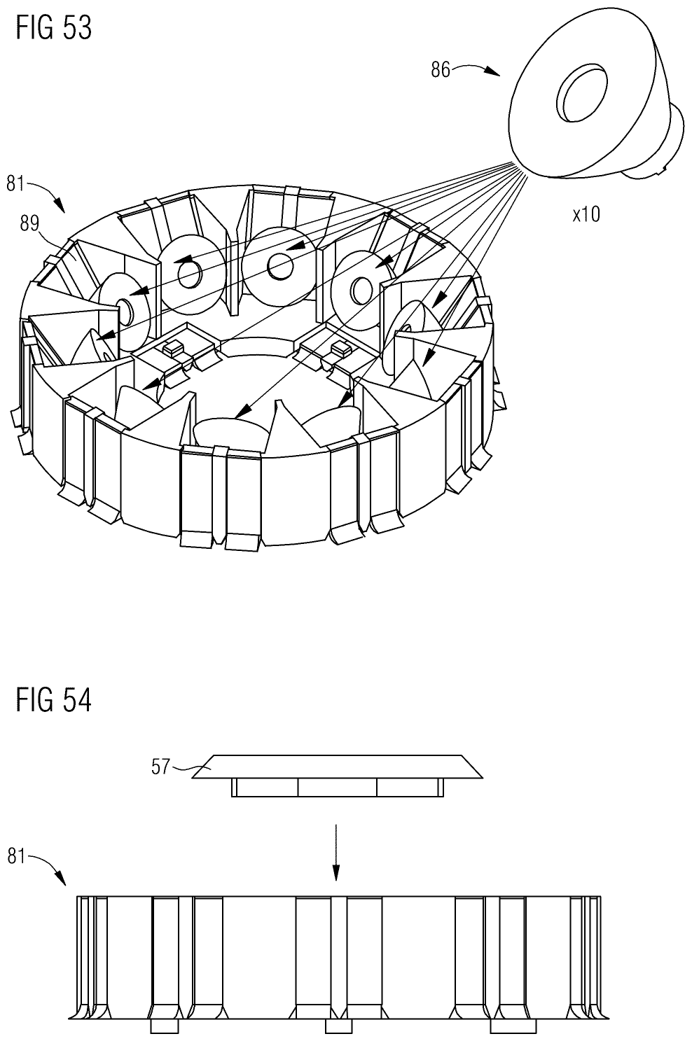

In the step of FIG. 52, the bonding material 71 for the individual reflectors 86 is applied around the light-emitting units 31 . . . 3M, for example, in three arcs of the same shape. Then, see FIG. 53, the individual reflectors 86 are attached to the housing body 81 by means of the bonding material 71. As in all other embodiments, instead of or in combination with the individual reflectors 86, individual lenses 74 can be used, compare, for example, FIG. 23. As an option, central optics 57 can be applied on the central placement area 93. The central optics 57 is for the additional light-emitting units 61 and covers all of these. For example, the central optics 57 has reflective side walls and internal reflective structure so that the light of the additional light-emitting units 61 is emitted from the central placement area 93 in a direction away from the mounting plane.

The finished light source 3 is illustrated in FIG. 55 and the manufacturing method is summarized in FIG. 56.

As an option, not shown in FIGS. 49 to 56, there can be the common optics element, like in FIG. 25 to 29 or 31, for example.

In summary, with the method of FIGS. 49 to 55, a 3D MID housing as an unique housing is realized by means of plastic injection molding and an LDS process and metal coating. Many emitters and lenses can be connected with conductive paste/adhesive to the 3D MID housing. Non-conductive adhesive can be used to fix the lenses or reflectors to the 3D MID housing, wherein a special pick-and-place machine may be used to assemble emitters and lenses directly to the 3D MID housing. The special pick-and-place machine may be able to hold only a single 3D MID housing or a limited amount of them. Conductive paste/adhesive can be used to connect the 3D MID housing assembly to any substrate.

Otherwise, the same as to FIGS. 1 to 48 may also apply to FIGS. 49 to 55, and vice versa.

In FIGS. 57 to 68, another example for producing the light source 3 is illustrated. According to FIG. 57, a plurality of housing slices 51 are produced which are of identical fashion. To simplify the drawing, in FIG. 57 only one of the housing slices 51 is shown. As for the housing body of FIGS. 49 to 56, the housing slice 51 can be an MID made of an opaque electrically insulating material 53.

Each one of the housing slices 51 has one recess 89 and the mounting wall 96. For example, the mounting wall 96 runs in an inclined manner but is of approximately plane parallel design. That is, the inward faces of the mounting wall 96 can run in parallel with the respective outward faces. Lateral faces of the housing slices 51 are formed of the screens 55. The lateral faces can be of plane construction.

Overall, disregarding the recess 89, the individual housing slices 51 can be of rhombic fashion having a trapezoidal bottom and top face.

According to FIG. 58, the conductor tracks are created, for example, by LDS in combination with plating, like in FIG. 50.

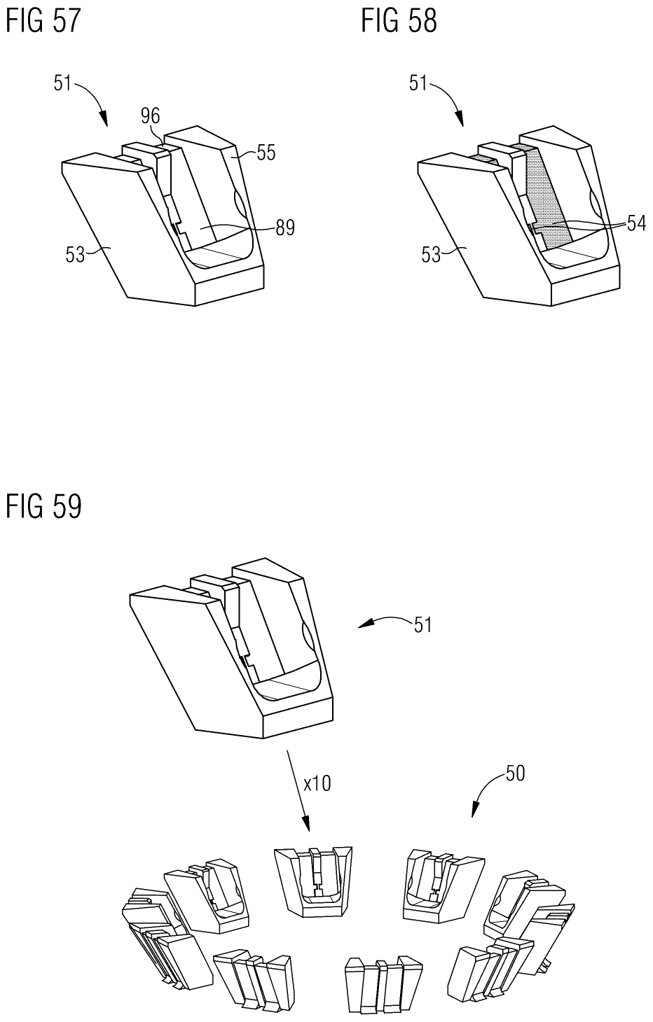

In FIG. 59 it is illustrated that the later housing 50 can be composed of a plurality of the identical housing slices 51. Just as an example, there are ten of the housing slices 51 to constitute the overall housing 50.

Back to the individual housing slices 51, see FIG. 60, it is illustrated that the mounting walls 96 are of plane parallel fashion at least in a placement area of the light-emitting units 31 . . . 3M and of the individual reflectors 86 so that a pick-and-place machine can be used to mount the light-emitting units 31 . . . 3M. For doing so, the housing slices 51 can be turned to bring the outward face of the mounting wall 96 in a horizontal orientation, for example.

After the light-emitting units 31 . . . 3M have been placed, the bonding material 71 is applied around the light-emitting units 31 . . . 3M, see FIG. 61, in the same manner as the light-emitting units 31 . . . 3M themselves.

Then, see FIG. 62, the individual reflectors 86 are placed over the light-emitting units 31 . . . 3M by means of the bonding material 71.

According to FIG. 63, a number of the individual housing slices 51 is assembled to create the overall housing 50. This is done, for example, by connecting the housing slices 51 directly to one another. However, in FIG. 63 another approach is illustrated. That is, the common circuit board 9 is provided and the housing slices 51 are, for example, soldered directly to corresponding contact pads at the common circuit board 9. The common circuit board 9 can be a mounting platform of the light source 3 itself, so that the common circuit board 9 is then arranged in a mobile device 10, for example, or the common circuit board 9 is a part of the mobile device 10 itself so that no intermediate mounting platform of the light source 3 is required. Hence, the individual housing slices 51 may directly be mounted in the mobile device 10, for example.

In the optional step of FIG. 64, the central optics 57 and the additional light-emitting units 61 are applied directly at the common circuit board 9. Otherwise, the central optics 57 and/or the additional light-emitting units 61 can be applied at the housing 50 as well. Moreover, it is possible that the additional light-emitting units 61 are first attached at the central optics 57 and then the central optics 57 is fixed to the housing slices 51 of the housing 51.

The resulting arrangement with the housing 50, the central optics 57 and the additional light-emitting units 61 is illustrated in FIG. 65 in a view from below. The finished light source 3 with the optional additional light-emitting units 61 and the optional central optics 57 is also illustrated in a sectional view in FIG. 66.

As schematically illustrated in FIG. 67, it is possible that there is a gap 52, like an air gap, between adjacent housing slices 51. Hence, positions of the housing slices 51 relative to one another can be fixed by means of the common circuit board 9 and optionally also by means of the central optics 57, but there does not need to be a connection through the housing slices themselves.

The manufacturing method is summarized in FIG. 68.

In summary, with the method of FIGS. 57 to 68, many 3D MID sections can be used to compose the 3D MID housing assembly so that the housing configuration can be simplified having it divided in multiple radial slices. Many emitters and lenses or reflectors can be applied; a conductive paste/adhesive can be used to connect the emitters each to the 3D MID sections, and a non-conductive adhesive can be used to fix the lenses or reflectors to each 3D MID section. A 3D MID carrier can be a holder with a flat plane with a tape, a tape with a frame, or the like. Each 3D MID housing section can be positioned in a tilted position in compliance with the required assembly tolerances. The 3D MID carrier can host many, for example, thousands, of the 3D MID sections. A standard pick-and-place machine may be used to assemble emitters and lenses/reflectors on each 3D MID section. Many 3D MID emission sub-assemblies can thus be obtained. A simple or standard robot having three or four axis may be used as a picking means, having or not rotating capabilities. Many 3D MID emission sub-assemblies can be tilted in and positioned in a tray or other holding means. A substrate to recombine and connect each section by mean of conductive paste/adhesive or other conductive means can be used.

Otherwise, the same as to FIGS. 49 to 56 may also apply to FIGS. 57 to 68, and vice versa.

That is, with the methods of FIGS. 49 to 56 and 57 to 68 the light source 3 and the picture recording arrangement 1 can be produced particularly efficiently. This is enabled, for example, by the following aspects that can be realized individually or in any combination:
The emission sub-groups wirings are integrated in the module single housing which is a 3D MID housing, realized by means of an LDS process and metal coating, for example, in a plating bath.
Emitters and lenses are assembled directly to the housing by means of a special pick-lace machine, obtaining a 3D MID housing assembly.
The special pick-and-place machine can hold only a single 3D MID housing or a limited amount of them.
The 3D MID housing assembly can be directly attached to a device substrate by mean of conductive paste/adhesive or other conductive mean.
The 3D MID housing assembly can be also simplified having it divided in multiple radial slices, that is, 3D MID sections.
Each 3D MID section is positioned in a tilted position on a 3D MID carrier to hold it in compliance with assembly tolerances, for example, using a flat plane with a tape, a tape only, or the like.
The 3D MID carrier can host many, for example, thousands, of the 3D MID sections.
Emitters 31.3M and lenses/reflectors 74, 86 can be assembled by means of a standard pick-and-place machine to each 3D MID section in, for example, a tilted configuration, and many, like thousands, 3D MID emission sub-assemblies can be obtained.
Many, for example, thousands, of the 3D MID emission sub-assemblies can be tilted in and positioned in a tray or other holding, means by usage of a simple/standard robot with three or four axis or the like, with a picking means having or not rotating capabilities, and so on.
3D MID emission sub-assemblies can be recombined and assembled directly to the device substrate or can be assembled to a substrate in order to realize a single module.
Each 3D MID emission sub-assembly can be connected to any substrate by mean of conductive paste/adhesive or other conductive means.

Thus, high-quality photographic applications not available in consumer environment with comparable hardware are enabled, and an easy manufacturability and scalability to mass production is permitted.

Hence, using 3D MID housing provides an unique platform that can hold many emitters and lenses at same time this is advantageous since with the aim of LDS and metal coating it serves as connection routing means for emitters and device substrate by means of conductive paste/adhesive or other conductive means. With the usage of a 3D MID housing an additional substrate, like a PCB or an RFPC, to route signals from the device and the emitters, is not needed with a clear advantage concerning size reduction, complexity reduction, and cost savings. Scalability to mass production volumes is also improved since emitters and lenses can be assembled by mean of a pick-and-place machine, manual handling and assembly is not required. The pick-and-place machine may hold only a single 3D MID housing or a small amount of them on each assembly batch, for example, in the case of the method of FIGS. 49 to 56.

In the 3D MID sections, there are multiple radial slices of the 3D MID housing leading to advantageous since with the aim of LDS and metal coating, each single 3D MID slice serves as connection routing means between a single emitter and a substrate, for example. The substrate may be the device substrate or a substrate to recombine and connect each section by means of a conductive paste/adhesive or other conductive mean. With the usage of 3D MID sections, the overall assembly process gain in:
simplicity: sections are identical to each other, this means they can be realized in high volumes series production;
flexibility: subsequent assembly processing is simple since it doesn't need a special pick-and-place machine; the process could be realized using many different standard pick-and-place machines in different production plants all over the world and doesn't need long process setup time; just in time production method is strongly enabled;
testability: each 3D MID emission sub-assembly can be singularly tested before the recombination on a substrate is done; in this way, defect detectability is dramatically increased and thus overall yield;
scalability to mass production: by the usage of a 3D MID carrier capable to host thousands 3D MID section, many 3D MID emission sub-assemblies can be obtained after a standard pick-and-place process. A standard robot can be used for assemblage.

The picture recording arrangement 1 according to the exemplary embodiment in FIG. 69 comprises an image sensor 2, such as a CCD chip with an array of pixels, as well as a light source 3. An optical axis 20 of the light source 3 and an optical axis 20 of the image sensor 2 are arranged parallel to each other. The light source 3 comprises a plurality of light-emitting units 31 . . . 3M and emits electromagnetic radiation R along a plurality of non-parallel emission directions D1 . . . DM (in FIG. 69 only one emission direction D1 is shown for better clarity). Each light-emitting unit 31 . . . 3M comprises a light emitting diode chip.

An emission angle 23 between each emission direction D1 . . . DM and the optical axis 20 of the light source 3 is changeable during operation of the light source 3. In particular, the emission angle 23 can be tuned between 40° and 60°, inclusive. The emission angle 23 can be tuned continuously or in discrete steps.

The light source 3 is configured as an indirect photo flash to illuminate an external object 4 while the image sensor 2 records a picture of the object 4. In particular, electromagnetic radiation R emitted by the light source 3 does not directly illuminate the object 4. In other words, the light source 3 does not emit electromagnetic radiation R in the field of view 22 of the image sensor 2. In particular, this applies at least at an intended image taking distance L1 between the object 4 to be imaged and the picture recording arrangement 1. In other words, electromagnetic radiation R directly emitted by the light source 3 may cross the field of view 22 of the image sensor 2 at distances from the light source 3 that are substantially smaller than the distance L1 between the light source 3 and the object 4, for example. Rather, electromagnetic radiation R is emitted by the light source 2 towards a reflective or scattering surface, such as a wall 12 for example. The wall 12 redirects the electromagnetic radiation R at least partially towards the object 4 and thus illuminates it indirectly. Furthermore, the light source 3 does not directly illuminate the image sensor 2.

The emission angle 23 can be changed in order to allow for a better illumination of the object 4 depending on the distance L1 between the light source 3 and the object 4, as well as the distance L2 between the light source 3 and the wall 12. For example, the emission angle 23 is smaller the larger the distance L1 between the light source 3 and the object 4 is.

The light source 3 according to the exemplary embodiment shown schematically in FIGS. 70 and 71 is configured to change the plurality of emission directions D1 . . . DM during operation, depending on a zoom state of the image sensor 2 (not shown in FIGS. 70 and 71). FIG. 70 shows a field of view 22 of an image sensor 2 in a wide angle zoom state, whereas FIG. 71 shows the field of view 22 in a tele zoom state. In both cases the plurality of emission directions 31 . . . . DM are adjusted such that the electromagnetic radiation R is emitted by the light source 3 along the emission directions D1 . . . DM outside the field of view 22 of the image sensor 2.

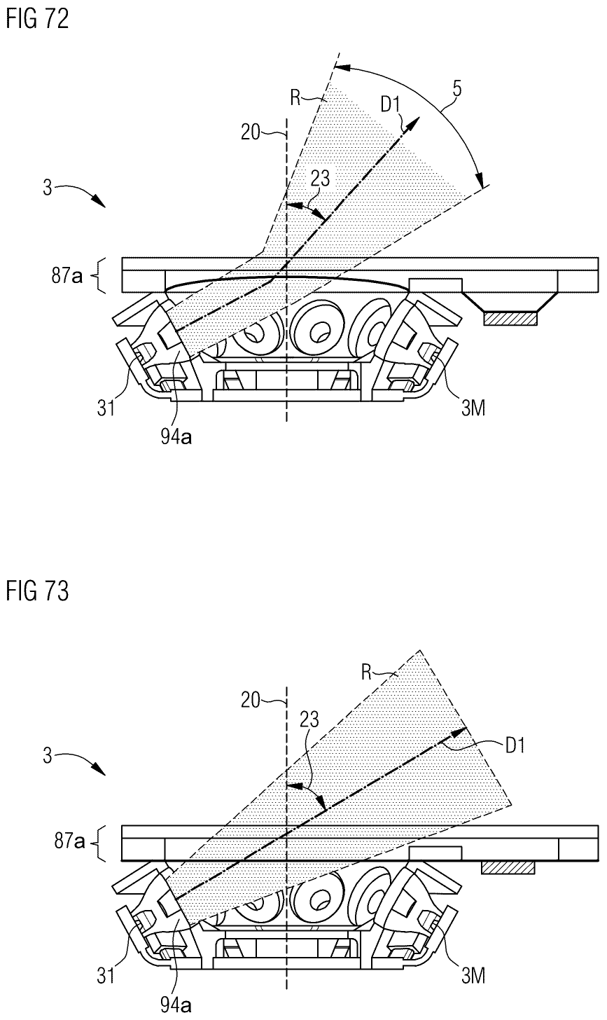

The light source 3 according to the exemplary embodiment shown in the cross sections of FIGS. 72 and 73 comprises a plurality of individually controllable light-emitting units 31 . . . 3M arranged in a circular manner around an optical axis 20 of the light source 3 as well as a tunable liquid lens 87a. Each light-emitting unit 31 . . . 3M is followed by a collimator 94a in the form of an appropriately shaped reflective surface, such that the electromagnetic radiation R is emitted in the form of a plurality of collimated light beams that are emitted in different, non-parallel directions crossing the optical axis 20 (for clarity only one of the light beams is shown). In other words, the light-emitting units 31 . . . 3M are tilted towards the optical axis 20. For each emission direction D1 . . . DM there is exactly one corresponding light-emitting unit 31 . . . 3M. The electromagnetic radiation R is collimated such that the light source 3 emits light beams with a given emission angle width 5.

The tunable liquid lens 87a is described in detail in connection with FIGS. 74 and 75. In particular, an optical axis 20 of the liquid lens 87a is parallel to the optical axis 20 of the light source 3. Electromagnetic radiation R emitted by the plurality of light-emitting units 31 . . . 3M passes through the liquid lens 87a and may be refracted and thus redirected, depending on a shape of the liquid lens 87a. In particular, the emission directions D1 . . . DM can be changed by tuning the shape of the liquid lens 87a.

FIG. 72 shows a configuration, where the liquid lens 87a is in a concave state, such that the light beam is refracted towards the optical axis 20. Accordingly, the emission angle 23 is smaller when the liquid lens is in a concave configuration. By contrast, FIG. 73 shows the liquid lens in a neutral or flat configuration. Accordingly, the emission directions D1 . . . DM are not changed by the liquid lens 87a and the emission angle 23 is bigger compared to the concave configuration of the liquid lens 87a shown in FIG. 72. The emission angle 23 can be changed continuously by tuning the shape of the liquid lens 87a.

FIG. 74 shows a schematic cross section of a liquid lens 87a in three different configurations: convex, flat and concave (from top to bottom), while FIG. 75 shows a top view of the liquid lens 87. The liquid lens 87 comprises an optical 876 section and an actuation section 877 that are connected via a pump channel 873. Each section 876, 877 further comprises a compartment delimited by a cover glass 874 and a flexible membrane 872. The compartment is filled with a transparent optical liquid 871. The flexible membrane 872 in the optical section is transparent, such that electromagnetic radiation can pass through the liquid lens 87a.

An actuator 875, such as a piezo actuator, is attached to the flexible membrane 872 in the actuation section 877. By operating the actuator 875, the flexible membrane 872 in the actuation section 877 can be pushed or pulled (indicated by the arrows in FIG. 74), thereby changing the amount of optical liquid in the optical section 876 and thus changing the shape and/or thickness of the liquid lens 87a. The aperture 878 of the liquid lens 87a shown in FIG. 75 may be circular, for example.

FIGS. 76, 77 and 78 show simulated emission patterns of electromagnetic radiation R emitted by one of the light-emitting units 31 . . . 3M of a light source 3 according to an exemplary embodiment. In particular, the electromagnetic radiation R is further collimated by an individual lens 74, such that the emitted electromagnetic radiation R has an emission angle width 5, and further passes through a liquid lens 87a. In particular, FIGS. 76, 77 and 78 show simulated emission patterns for different configurations of the liquid lens 87a. FIG. 76 corresponds to a liquid lens 87a in a concave configuration, while FIGS. 77 and 78 correspond to a liquid lens 87a in a flat and a convex configuration, respectively.

In each of FIGS. 76, 77 and 78 the left panel shows a cross section with a plurality of light rays emitted by the light-emitting unit 31 relative to an optical axis 20. The middle panel shows a contour plot of an intensity distribution of the electromagnetic radiation R far away from the light source 3 on the surface of a sphere with the light source 3 at its center. In other words, along the radial direction of the middle panel a polar angle or emission angle changes, whereas the angular direction in the middle panel corresponds to an azimuthal angle. The right panel shows a corresponding polar plot of an intensity distribution of the emitted electromagnetic radiation R as a function of the emission angle 23.

In FIG. 76 the electromagnetic radiation R is primarily emitted at an emission angle 23 of approximately 25°, whereas in FIGS. 77 and 78 the emission angles 23 are approximately 30° and 34°, respectively. In this example, the emission angle 23 can be tuned continuously within the range from 25° to 34°.

FIGS. 79 and 80 show simulated emission patterns of electromagnetic radiation R emitted along one of the plurality of emission directions D1 . . . DM of a light source 3 according to a further exemplary embodiment. The light source 3 comprises one freeform individual lens 74 for collimating electromagnetic radiation R and two corresponding light-emitting units 31, 32 per emission direction D1. The two light-emitting units 31, 32 are arranged off-centered from an optical axis 20 of the individual lens 74. The optical axis 20 of the individual lens 74 forms an angle α with the optical axis 20 of the light source 3 (the vertical direction in FIGS. 79 and 80). The two light-emitting units 31, 32 are arranged in the plane spanned by the optical axis 20 of the individual lens 74 and the optical axis 20 of the light source 3.

By selectively switching the two light-emitting units 31, 32 on or off, the emission direction D1 and thus the emission angle 23 can be changed during operation. FIG. 79 shows the emission pattern, when the first light-emitting unit 31 is switched off and the second light-emitting unit 32 is switched on, whereas FIG. 80 shows the emission pattern, when the first light-emitting unit 31 is switched on and the second light-emitting unit 32 is switched off. By switching between the two light-emitting units 31, 32, the emission angle 23 can be changed between two discrete values during operation of the light source 3. In FIG. 79 the emission angle 23 is smaller than the angle α between the two optical axes 20, whereas in FIG. 80 the emission angle 23 is larger than the angle α between the two optical axes 20. Advantageously, the emission angles 23 for each emission direction D1 . . . DM can be changed independently during operation.

FIGS. 81, 82 and 83 show a calculated percentage of electromagnetic radiation R emitted by a light source 3 according to an exemplary embodiment that arrives at an external object 4. In particular, the calculation assumes the same arrangement of the light source 3, the wall 12 and the object 4 as shown in FIG. 69, i.e. the wall 12 is parallel to the optical axis 20 of the light source 3. Moreover, the calculation assumes that the wall 12 has an albedo between 0.5 and 1 and reflects electromagnetic radiation R according to Lambert's cosine law. The calculated percentage is plotted as a function of the distance L2 between the light source 3 and the wall 12.

FIG. 81 shows results for a distance L1 between the light source 3 and the object 4 of 2 meters, whereas FIGS. 82 and 83 show results for a distance L1 of 5 meters and 8 meters, respectively.

In each of the FIGS. 81, 82 and 83 results are shown for an emission angle 23 of 40° (first dataset 101) and for an emission angle 23 of 60° (second dataset 102). Moreover, for comparison results of the calculated percentage are shown for direct illumination, i.e. for an emission angle of 0° (third dataset 103). For example, the results in FIG. 82 show that an emission angle 23 of 40° is preferable for wall distances L2 between approximately 2 and 4 meters, whereas an emission angle of 60° is preferable for wall distances L2 larger than approximately 4 meters.

FIG. 84 shows a perspective view of a light source 3 according to an exemplary embodiment. In particular, the light source 3 comprises an individual lens 74 and two corresponding light-emitting units 31, 32 for each of the six emission directions D1 . . . D6 (not shown for clarity). The arrangement of each individual lens 74a, 74b, 74c and its two corresponding light-emitting units 31a, 32a, 31b, 32b, 31c, 32c, respectively, corresponds to the arrangement described in connection with FIGS. 79 and 80. Accordingly, for each of the six emission directions D1 . . . D6 the emission angle 23 can be changed between two discrete values during operation.

FIGS. 85 and 86 show simulated emission patterns of electromagnetic radiation R emitted by the light source 3 described in connection with FIG. 84. The left panels of FIGS. 85 and 86 show an intensity distribution of the electromagnetic radiation R emitted by the light source 3 on the surface of a sphere, analogous to the middle panels of FIGS. 76, 77 and 78, whereas the middle panels of FIGS. 85 and 86 show a polar plot of an intensity distribution of the emitted electromagnetic radiation R as a function of the emission angle 23, analogous to the right panels of FIGS. 76, 77 and 78. The right panels of FIGS. 85 and 86 show an intensity distribution of the emitted electromagnetic radiation R on a flat surface perpendicular to the optical axis 20 of the light source 3 at a fixed distance L1.

In particular, FIG. 85 shows the emission pattern when the second light emitting-units 32a, 32b, 32c are switched on and the first light-emitting units 31a, 31b, 31c are switched off, whereas FIG. 86 shows the emission pattern when the second light emitting-units 32a, 32b, 32c are switched off and the first light-emitting units 31a, 31b, 31c are switched on. In FIG. 85 the emission angle 23 is approximately 40°, whereas in FIG. 86 the emission angle is approximately 60°, with an emission angle width 5 of approximately 15° in both cases.

FIG. 87 shows a perspective view of a light source 3 according to a further exemplary embodiment. In particular, the light source 3 comprises an individual lens 74 and two corresponding light-emitting units 31, 32 for each of the six emission directions D1 . . . D6 (not shown for clarity). In contrast to the light source 3 described in connection with FIG. 84, the light-emitting units 31, 32 for each individual lens 74 in FIG. 87 are arranged in a plane perpendicular to the optical axis 20 of the light source 3. Accordingly, an azimuthal angle can be switched for each emission direction D1 . . . D6 by selectively switching the two light-emitting units 31, 32 on or off. Alternatively, the light source 3 may comprise 12 emission directions D1 to D12 by switching both light-emitting units 31, 32 on at the same time. In other words, the light source 3 may comprise twelve emission directions D1 . . . D12, while only six individual lenses 74 are needed for collimation of the electromagnetic radiation R. Therefore the light source 3 may be particularly compact.

FIG. 88 shows an relative illumination error Err as a function of the number Num of emission directions D1 . . . DM for a light source 3 according to an exemplary embodiment. In particular, the relative illumination error Err is a measure of a difference between an image recorded under natural lighting conditions and an image recorded while the object 4 is illuminated by the light source 3. In particular, the illumination error decreases with increasing number of emission directions.

FIG. 89 shows a diameter A of a light source 3 in a plane perpendicular to the optical axis 20 of the light source 3 as a function of the number Num of emission directions D1 . . . DM.

FIG. 90 shows an intensity distribution of the electromagnetic radiation R emitted by the light source 3 shown in FIG. 87 on the surface of a sphere, analogous to the middle panels of FIGS. 76, 77 and 78. In particular, FIG. 90 shows the intensity distribution when all light-emitting units 31, 32 are switched on and the electromagnetic radiation R is emitted along 12 emission directions D1 . . . D12. The emission directions D1 . . . D12 each have an emission angle 23 of approximately 60°.

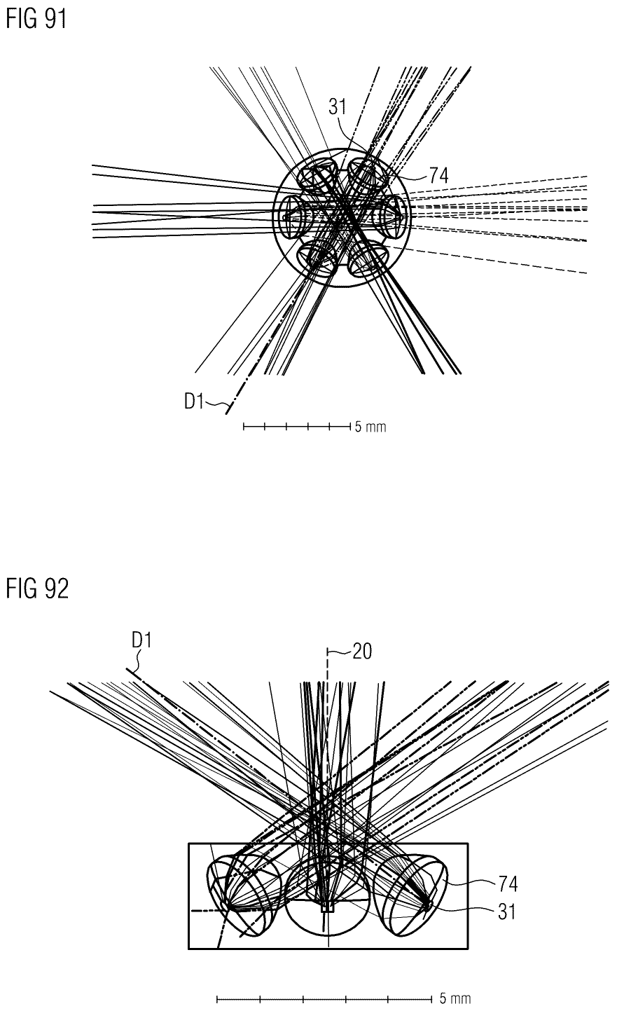

FIGS. 91 to 94 show numerical simulations of emission patterns of electromagnetic radiation R emitted by two different light sources 3 according to different examples.

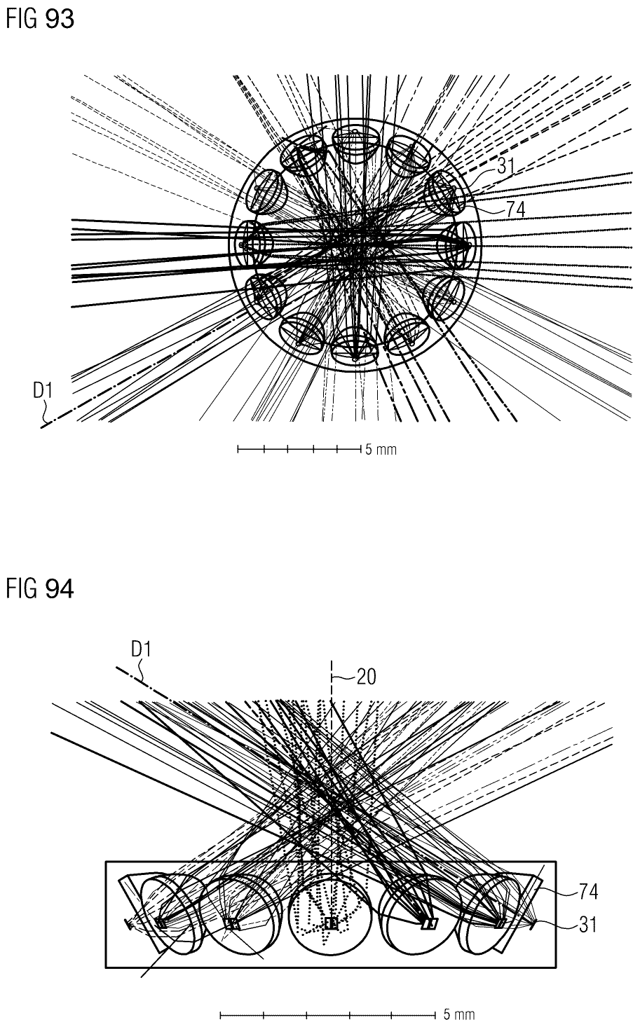

FIGS. 91 and 93 show a top views along the optical axis 20 of the respective light sources 3, whereas FIGS. 92 and 94 show schematic cross sections of the respective light sources 3. The light source 3 in FIGS. 91 and 92 comprises six light-emitting units 31 . . . 36, six corresponding individual lenses 74 and has six corresponding emission directions D1 . . . D6 arranged in a circular manner around the optical axis 20 of the light source 3. The light source 3 in FIGS. 93 and 94 comprises twelve light-emitting units 31 . . . 312, twelve individual lenses 74 and has twelve corresponding emission directions D1 . . . D12 arranged in a circular manner around the optical axis 20 of the light source 3.

FIG. 95 shows a perspective view of a light source 3 according to a further exemplary embodiment. In particular, the light source 3 comprises six individual lenses 74 arranged in a circular manner around an optical axis 20 of the light source 3 and four light-emitting units 31, 32, 33, 34 for each of the six individual lenses 74. The four light-emitting units 31, 32, 33, 34 for each individual lens 74 are arranged off-centered from the optical axis 20 of the corresponding individual lens 74 in the form of a quadratic 2 by 2 array. In particular, the arrangement of the four light-emitting units 31, 32, 33, 34 for each individual lens 74 is a combination of the arrangements described in connection with FIGS. 84 and 87. The light source 3 shown in FIG. 95 has twelve emission directions D1 . . . D12 that can be changed individually between two discrete emission angles 23 during operation. Moreover, the light source 3 is particularly compact, as only six individual lenses 74 for collimation of the electromagnetic radiation R emitted along twelve emission directions D1 . . . D12 are needed.

FIGS. 96 and 97 show simulated emission patterns of electromagnetic radiation R emitted by the light source 3 described in connection with FIG. 95. The left panels of FIGS. 96 and 97 show an intensity distribution of the electromagnetic radiation R emitted by the light source 3 on the surface of a sphere, analogous to the middle panels of FIGS. 76, 77 and 78, whereas the right panels of FIGS. 96 and 97 show an intensity distribution of the emitted electromagnetic radiation R on a flat surface perpendicular to the optical axis 20 of the light source 3 at a fixed distance L1. In particular FIG. 96 shows the emission pattern when the light-emitting units 31 and 32 are switched on and the light-emitting units 33 and 34 are switched off such that electromagnetic radiation R is emitted at an emission angle of approximately 60°, whereas FIG. 97 shows the emission pattern when the light-emitting units 31 and 32 are switched off and the light-emitting units 33 and 34 are switched on, such that electromagnetic radiation R is emitted at an emission angle of approximately 40°.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

This patent application claims the priority of German patent applications DE 10 2022 114 174.8, DE 10 2022 117 234.1, DE 10 2022 123 473.8 and DE 10 2022 133 387.6, the disclosure content of which is hereby incorporated by reference.

### LIST OF REFERENCE SIGNS

1 picture recording arrangement
10 mobile device
11 scene
12 wall
13 illuminated area
2 image sensor
20 optical axis
22 field of view
23 emission angle
3 light source
3 . . . light-emitting unit
4 target/object
5 emission angle width
50 housing
51 housing slice
52 gap
53 electrically insulating material
54 electrically conductive structure
55 screen
56 additional recess
57 central optics
61 additional light-emitting unit
62 emitter for non-visible radiation
63 3D-sensor
7 processing unit
71 bonding material
72 solder
73 socket
74 individual lens
75 common reflective wall
76 connection area
77 ledge
81 housing body
82 luminescent layer
83 encapsulation body
84 wire
85 LED chip
86 individual reflector
87 common optics element
87a liquid lens
871 optical liquid
872 membrane
873 pump channel
874 cover glass
875 actuator
876 optical section
877 actuation section
878 aperture
88 redirectional optics
89 recess
9 common circuit board
91 central part
92 mounting strip
93 placement area
94 reflector wall
94a collimator
95 rim
96 mounting wall
97 placement means
98 cover part
99 connection part
101 first dataset
102 second dataset
103 third dataset
A diameter
D . . . emission direction
H size
L distance
L1 distance
L2 distance
R radiation
a angle
Err relative error
Num number of emission directions

1. A picture recording arrangement comprising:
an image sensor, and
a light source configured to emit radiation along a plurality of emission directions,
wherein
the light source comprises a plurality of independently controllable light-emitting units,
for each one of the emission directions, there is at least one of the light-emitting units, and
the radiation emitted into the emission directions is emitted predominantly out of a field of view of the image sensor.

2. The picture recording arrangement according to claim 1,
wherein an emission angle between an optical axis of the image sensor and at least some of the emission directions is between 30° and 75° inclusive,
wherein for at least some of the emission directions an emission angle width per emission direction is between 15° and 45° inclusive.

3. The picture recording arrangement according to claim 1,
wherein the light-emitting units are arranged in a circular manner, seen in top view of the image sensor.

4. The picture recording arrangement according to claim 3,
wherein the emission directions point inwards and there is a common point of intersection of the emission directions.

5. The picture recording arrangement according to claim 1,
further comprising a housing body,
wherein the light-emitting units are separate devices all fixed to the housing body,
wherein the housing body comprises a plurality of recesses the light-emitting units are arranged at.

6. The picture recording arrangement according to claim 1,
further comprising a housing,
wherein the housing is composed of a plurality of housing slices of identical construction,
wherein each one of the housing slices carries at least one of the light-emitting units.

7. The picture recording arrangement according to claim 1,
wherein the light-emitting units are placed on and electrically connected with mounting strips in a periphery of a common circuit board,
wherein the mounting strips are bent relative to a central part of the common circuit board.

8. The picture recording arrangement according to claim 1,
further comprising a common circuit board carrying all the light-emitting units and the light-emitting units being arranged in parallel with each other on the common circuit board,
wherein at least some of the light-emitting units are followed by redirectional optics for defining the emission directions.

9. The picture recording arrangement according to claim 1,
further comprising at least one common optics element being optically downstream of all the light-emitting units.

10. The picture recording arrangement according to claim 1,
wherein, seen in top view of the image sensor, the light-emitting units surround a placement area in which the image sensor and/or a further optoelectronic unit is located.

11. A light source comprising a plurality of independently controllable light-emitting units, wherein
the light source is configured to emit electromagnetic radiation along a plurality of non-parallel emission directions during operation,
for each of the emission directions, there is at least one of the light-emitting units,
an emission angle between an optical axis of the light source and each of the emission directions can be changed during operation of the light source.

12. The light source according to claim 11, wherein
the light source is configured as an indirect photo flash.

13. The light source according to claim 11,
wherein the light source further comprises a tunable lens with an optical axis parallel to the optical axis of the light source.

14. The light source according to claim 11,
wherein
the emission angle for each emission direction can be changed independently, and
the emission angle for each emission direction can take at least two discrete values.

15. The light source according to claim 11, further comprising a plurality of individual lenses, wherein
each individual lens is configured for collimating the electromagnetic radiation emitted by at least two corresponding light-emitting units, and
the at least two light-emitting units are arranged off-centered from an optical axis of the corresponding individual lens.

16. The light source according to claim 15, wherein
the optical axis of each individual lens forms an angle with the optical axis of the light source, and
the at least two light-emitting units are arranged in a plane spanned by the optical axis of the light source and the optical axis of the corresponding individual lens.

17. A picture recording arrangement comprising,
a light source according to claim 11, and
an image sensor, wherein
the electromagnetic radiation emitted by the light source is emitted predominantly out of a field of view of the image sensor.

18. A method for operating a picture recording arrangement according to claim 17, comprising the steps of:
recording a series of images under different lighting conditions with the image sensor, such that each image is recorded while electromagnetic radiation is emitted along a single corresponding emission direction,
determining optimal intensities of the electromagnetic radiation emitted along each of the plurality of emission directions by comparing the recorded series of images with another image recorded by the image sensor under natural lighting conditions,
recording an image while the light source emits electromagnetic radiation according to the previously determined optimal intensities of the electromagnetic radiation along each of the emission directions.

19. Method according to claim 18, wherein
the series of images comprises images taken at different emission angles, and
determining the optimal intensities includes determining an optimal emission angle for each of the emission directions.

20. The picture recording arrangement according to claim 1, wherein the light source corresponds to the light source according to claim 11.
